(19) United States
(12) Patent Application Publication
(10) Pub. No.: US 2013/0122960 A1
(43) Pub. Date: May 16, 2013

(54) MOBILE TERMINAL AND CONTROLLING METHOD THEREOF

(71) Applicants: Miyoung KIM, Seoul (KR); Youneui CHOI, Seoul (KR); Jeeyeon KIM, Seoul (KR)

(72) Inventors: Miyoung KIM, Seoul (KR); Youneui CHOI, Seoul (KR); Jeeyeon KIM, Seoul (KR)

(73) Assignee: LG ELECTRONICS INC., Seoul (KR)

(21) Appl. No.: 13/617,606

(22) Filed: Sep. 14, 2012

(30) Foreign Application Priority Data
Nov. 16, 2011 (KR) 10-2011-0119389

(51) Int. Cl. H04W 88/02

(52) U.S. Cl. 455/566

(57) ABSTRACT

A mobile terminal and controlling method thereof are disclosed. The present invention includes a display unit, a wireless communication unit performing a communication with at least one external terminal, a memory, and a controller controlling a 1^{st} image in a full image of a 1^{st} content and a 2^{nd} image different from the 1^{st} image in the full image of the 1^{st} content to be simultaneously displayed on the display unit and the at least one external terminal, respectively.

Pursuant to 35 U.S.C. §119(a), this application claims the benefit of earlier filing date and right of priority to Korean Application No. 10-2011-0119389, filed on Nov. 16, 2011, the contents of which are hereby incorporated by reference herein in their entirety.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for implementing a multi-screen using an external terminal.

2. Discussion of the Related Art

Generally, terminals can be classified into mobile/portable terminals and stationary terminals. The mobile terminals can be further classified into handheld terminals and vehicle mount terminals according to possibility of user's direct portability.

As functions of the terminal are getting diversified, the terminal tends to be implemented as a multimedia player provided with composite functions such as photographing of photos or videos, playback of music or video files, game play, broadcast reception and the like for example.

To support and increase the terminal functions, it may be able to consider the improvement of structural parts and/or software parts of the terminal.

As a mobile terminal turns into a multi-functional device, a quality of a content activated in the mobile terminal is increasing. As the need for a content of high quality and high-definition is raised, a size of a screen of a mobile terminal gradually increases as well.

However, the screen size increase may raise weight of the mobile terminal and lower the portability of the mobile terminal.

Moreover, although a user is able to share a content retained by a mobile terminal with an external terminal using a short-range communication, it may be able to display a content selected by each terminal user only. Therefore, it may be difficult for a plurality of users to share the same user experience through the shared content.

### SUMMARY OF THE INVENTION

Accordingly, the present invention is directed to a mobile terminal and controlling method thereof that substantially obviate one or more problems due to limitations and disadvantages of the related art.

An object of the present invention is to provide a mobile terminal and controlling method thereof, by which a multi-screen may be implemented via one mobile terminal in a manner of extending a screen of a mobile terminal to a screen of an external terminal.

Another object of the present invention is to provide a mobile terminal and controlling method thereof, by which a display output may be controlled in consideration of a display specification difference between an external terminal and a mobile terminal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile terminal according to the present invention may include a display unit, a wireless communication unit performing a communication with at least one external terminal, a memory, and a controller controlling a 1^{st} image in a full image of a 1^{st} content and a 2^{nd} image different from the 1^{st} image in the full image of the 1^{st} content to be simultaneously displayed on the display unit and the at least one external terminal, respectively.

As the 1^{st} content is partitioned into the 1^{st} image and the 2^{nd} image, the mobile terminal and the external terminal may display the 1^{st} image and the 2^{nd} image to provide a user with a content image through a wider screen.

Preferably, the controller may control an output of the display unit by comparing a display information of the display unit with a display information of the external terminal. And, the display information may include at least one selected from the group consisting of a screen resolution, a screen size and a screen brightness.

Through this, in consideration of the specification difference between the external terminal and the mobile terminal, the present invention may be able to adjust a size or resolution of the content to prevent the content from being unnaturally displayed between the mobile terminal and the external terminal.

Preferably, the controller may determine a presence (or non-presence) of the external terminal via a radio frequency signal received from the external terminal. More preferably, the radio frequency signal may include a communication signal of at least one selected from the group consisting of WiFi Direct, Bluetooth, Zigbee, RFID, UWB, IrDA, and NFC.

Using the above-enumerated short-range communication, the present invention minimizes a communication path between the mobile terminal and the external terminal, thereby enhancing communication efficiency.

More preferably, the controller may automatically or manually recognize a prescribed direction in which the external terminal is located with reference to the display unit. And, the controller may configure the 1^{st} image and the 2^{nd} image by partitioning the full image of the 1^{st} content into top and bottom parts or left and right parts in accordance with a location of the external terminal.

Preferably, the controller may control the display unit or the external terminal to output a screen rotated by 180 degrees, whereby the mobile terminal and the external terminal may operate in a manner that narrow bezel parts of the mobile and external terminals come into contact with each other in consideration of bezel widths of the mobile and external terminals.

Preferably, the controller may control the display unit to display the full image of the 1^{st} content and may further control the external terminal to display a full image of a 2^{nd} content different from the 1^{st} content at the same time.

Therefore, the present invention may control the mobile terminal and the external terminal to display different contents, respectively, thereby providing a user with a plurality of contents simultaneously.

More preferably, the controller may control a display mode of the display unit to be adjusted into a landscape mode or a portrait mode. And, the controller may control the external terminal to have the same display mode of the display unit.

In another aspect of the present invention, a method of controlling a mobile terminal may include the steps of controlling an entry into a multi-screen mode by a controller and if the multi-screen mode is entered, while the controller displays a 1^{st} image in a full image of a 1^{st} content saved in a memory, controlling a 2^{nd} image different from the 1^{st} image in the full image of the 1^{st} content to be displayed on an external terminal.

In a further aspect of the present invention, a computer-readable recording medium may include a program recorded therein to control a mobile terminal, the program including a command to control an entry into a multi-screen mode and a command, if the multi-screen mode is entered, while the controller displays a 1^{st} image in a full image of a 1^{st} content saved in a memory, the command to control a 2^{nd} image different from the 1^{st} image in the full image of the 1^{st} content to be displayed on an external terminal.

Accordingly, the present invention provides the following effects and/or advantages.

First of all, a mobile terminal according to at least one embodiment of the present invention outputs a content using both screens of the mobile terminal and an external terminal simultaneously, thereby enabling the content to be viewed through a wide screen.

Secondly, even if a display specification of a mobile is different from that of an external terminal, the present invention adjusts a size or resolution of a content, thereby preventing the content from being discontinuously displayed.

Thirdly, the present invention provides a system for facilitating an external terminal to receive a content saved in a mobile terminal.

Effects obtainable from the present invention may be non-limited by the above mentioned effect. And, other unmentioned effects can be clearly understood from the following description by those having ordinary skill in the technical field to which the present invention pertains.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to one embodiment of the present invention;

FIG. 2 is a front perspective diagram of a mobile or handheld terminal according to one embodiment of the present invention;

FIG. 3 is a flowchart for a method of controlling a mobile terminal according to one embodiment of the present invention;

FIG. 4 is a diagram for one example of a screen provided to determine a direction of an external terminal manually;

FIG. 5 is a diagram for one example to describe that a 1^{st} image and a 2^{nd} image are displayed on a 1^{st} display unit and an external terminal, respectively;

FIG. 6A and FIG. 6B are diagrams for examples to describe that a 1^{st} image and a 2^{nd} image are configured by partitioning a full image of each content into right & left parts or top & bottom parts;

FIG. 7 is a diagram for one example to describe that 1^{st} to 3^{rd} images are configured by partitioning a full image of a content if two external terminals are provided;

FIG. 8 is a diagram for one example that a display unit outputs a 180-degree rotated screen;

FIG. 9 is a detailed flowchart of the step of displaying 1^{st} and 2^{nd} images shown in FIG. 3;

FIG. 10A and FIG. 10B are diagrams for one example that a 1^{st} image and a 2^{nd} image are outputted to a 1^{st} display unit and a 2^{nd} display unit differing from each other in screen size;

FIG. 11A and FIG. 11B are diagrams for one example of screens provided to adjust sizes of 1^{st} and 2^{nd} images outputted via a 1^{st} display unit and an external terminal, respectively;

FIG. 12 is a diagram for one example that a 1^{st} display unit and an external terminal display a full image of a 1^{st} content and a full image of a 2^{nd} content, respectively;

FIG. 13 is a diagram for one example of contents saved in a memory 160;

FIGS. 14A to 14C are diagrams for one example of a case that a display mode of a mobile terminal in a screen partition mode is set to a landscape mode;

FIGS. 15A to 15C are diagrams for one example of a case that a display mode of a mobile terminal in a screen partition mode is set to a portrait mode;

FIG. 16A and FIG. 16B are diagrams for one example of a case that a display mode of a mobile terminal in a wide screen mode is set to a portrait mode or a landscape mode;

FIGS. 17A to 17C are diagrams for one example that a 1^{st} display unit and an external terminal are controlled to display a next or previous image in accordance with an external input in case of operation in a screen partition mode;

FIG. 18A and FIG. 18B are diagrams for one example of a screen provided to a user to fix an output of a 1^{st} display unit;

FIG. 19 is a diagram for one example of a user interface (UI) provided to a user to receive an original content;

FIG. 20A and FIG. 20B are diagrams for one example to describe a display change between a 1^{st} display unit and an external terminal when a mobile terminal in an active wide mode receives a message;

FIG. 21A and FIG. 21B are diagrams for one example to describe a display change between a 1^{st} display unit and an external terminal when a mobile terminal in an active screen partition mode receives a message;

FIG. 22A and FIG. 22B are diagrams for another example to describe a display change between a 1^{st} display unit and an external terminal when a mobile terminal in an active screen partition mode receives a message;

FIG. 23 is a diagram for one example of a screen when a multi-screen mode is paused;

FIG. 24A and FIG. 24B are diagrams for one example of a screen for enabling a controller to set a mobile terminal to enter a lock or unlock mode; and

FIG. 25 is a diagram for one example of a screen for displaying a full image of a video thumbnail via an external terminal.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are often used for elements in order to facilitate discussion of the disclosure. Therefore, significant meanings or roles are not given to the suffixes themselves and it is understood that the ‘module’, ‘unit’ and ‘part’ can be used together or interchangeably.

Various types of terminals may be implemented using the various techniques discussed herein. Examples of such terminals include mobile as well as stationary terminals, such as mobile phones, user equipment, smart phones, DTV, computers, digital broadcast terminals, personal digital assistants, portable multimedia players (PMPs), navigators, and the like. By way of non-limiting example only, further description will be with regard to a mobile terminal 100, and such teachings may apply equally to other types of terminals.

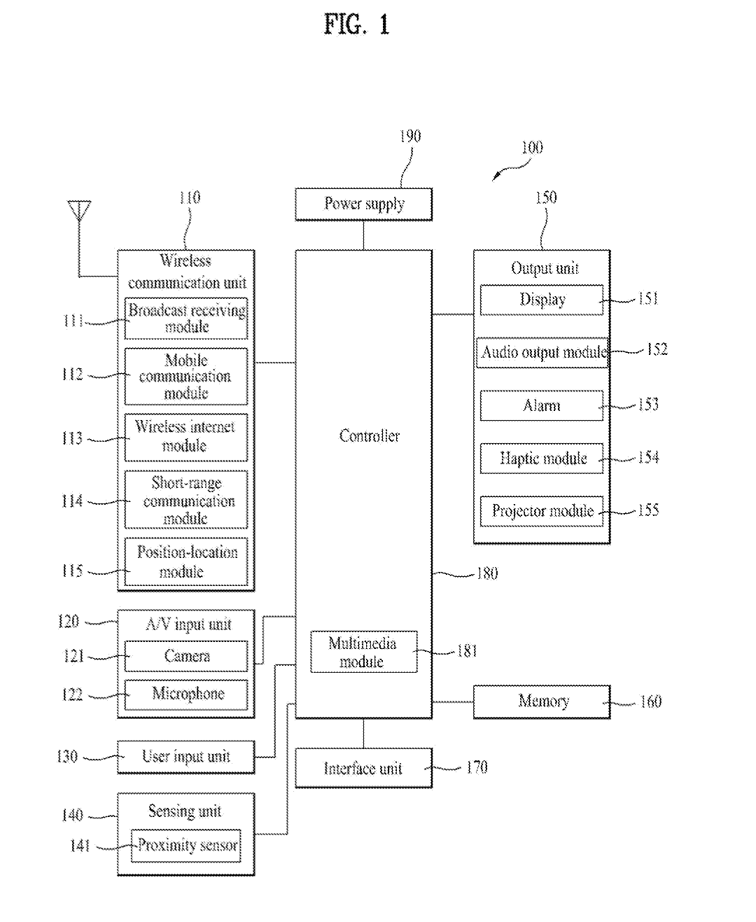

FIG. 1 is a block diagram of a mobile terminal 100 in accordance with an embodiment of the present invention. FIG. 1 shows the mobile terminal 100 having a wireless communication unit 110, an A/V (audio/video) input unit 120, a user input unit 130, a sensing unit 140, an output unit 150, a memory 160, an interface unit 170, a controller 180, a power supply unit 190, among other components. Mobile terminal 100 is shown having various components, but it is understood that implementing all of the illustrated components is not a requirement as greater or fewer components may alternatively be implemented.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115, and the like.

The broadcast receiving module 111 receives a broadcast signal and/or broadcast associated information from an external broadcast managing server via a broadcast channel. The broadcast channel may include a satellite channel and a terrestrial channel. The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

The broadcast associated information includes information associated with a broadcast channel, a broadcast program, a broadcast service provider, etc. This broadcast associated information can also be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Optionally, the broadcast receiving module 111 can be configured to be suitable for other broadcasting systems as well as the above-identified digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.). Such wireless signals may represent audio, video, and data according to text/multimedia message transceiving, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), and the like.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

Referring still to FIG. 1, the audio/video (A/V) input unit 120 is shown configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. Typically, the processed image frames can be displayed on the display 151.

The image frames processed by the camera 121 can be stored in the memory 160 or can be externally transmitted via the wireless communication unit 110. Optionally, two or more cameras 121 can be provided to the mobile terminal 100 according to the environment in which the terminal used to according to user needs.

The microphone 122 receives an external audio signal while the portable device is in a particular mode, such as phone call mode, recording mode and voice recognition mode. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, and the like.

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100.

As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. If desired, the sensing unit 140 can include a proximity sensor 141.

The output unit 150 generates outputs relevant to the senses of sight, hearing, touch and the like. In some cases, the output unit 150 includes the display 151, an audio output module 152, an alarm unit 153, a haptic module 154, a projector module 155, and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmissive type, which can be named a transparent display. As a representative example for the transparent display, there is TOLED (transparent OLED) or the like. A rear configuration of the display 151 can be implemented in the optical transmissive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In the case where the display 151 and a sensor for detecting a touch action (hereinafter also referred to a ‘touch sensor’) configures a mutual layer structure (hereinafter also referred to a ‘touchscreen’), the user can use the display 151 as an input device as well as an output device. In this case, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

With continued reference to FIG. 1, a proximity sensor (not shown in the drawing) can be provided to an internal area of the mobile terminal 100 enclosed by the touchscreen or proximate to the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one or more of a transmissive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor, and the like. When the touchscreen includes the electrostatic capacity proximity sensor, it may also be configured to detect the proximity of a pointer using a variation of electric field according to the proximity of the pointer. In this scenario, the touchscreen (touch sensor) can be classified as a proximity sensor.

In the following description, for clarity, an action that a pointer approaches without contacting with the touchscreen to be recognized as located on the touchscreen is referred to as ‘proximity touch’ while an action that a pointer actually touches the touchscreen may be referred to as a ‘contact touch’. The meaning of the position on the touchscreen proximity-touched by the pointer refers to the position of the pointer which vertically opposes the touchscreen when the pointer performs the proximity touch.

The proximity sensor detects a proximity touch and a proximity touch pattern (e.g., a proximity touch distance, a proximity touch duration, a proximity touch position, a proximity touch shift state, etc.). In addition, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The projector module 155 is the element for performing an image projector function using the mobile terminal 100. And, the projector module 155 is able to display an image, which is identical to or partially different at least from the image displayed on the display 151, on an external screen or wall according to a control signal of the controller 180.

In particular, the projector module 155 can include a light source (not shown in the drawing) generating light (e.g., laser) for projecting an image externally, an image producing element (not shown in the drawing) for producing an image to output externally using the light generated from the light source, and a lens (not shown in the drawing) for enlarging the image for output externally at predetermined focus distance. The projector module 155 can further include a device (not shown in the drawing) for adjusting an image projected direction by mechanically moving the lens or the whole module.

The projector module 155 can be classified into a CRT (cathode ray tube) module, an LCD (liquid crystal display) module, a DLP (digital light processing) module or the like according to a device type of a display means. In particular, the DLP module is operated by the mechanism of enabling the light generated from the light source to reflect on a DMD (digital micro-mirror device) chip and can be advantageous for the downsizing of the projector module 151.

Preferably, the projector module 155 can be provided in a length direction of a lateral, front or backside direction of the mobile terminal 100. It is understood that the projector module 155 can be provided to any portion of the mobile terminal 100 according to the necessity thereof.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures, moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on the Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identity Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component. Moreover, the controller 180 is able to perform a pattern recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such feature may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

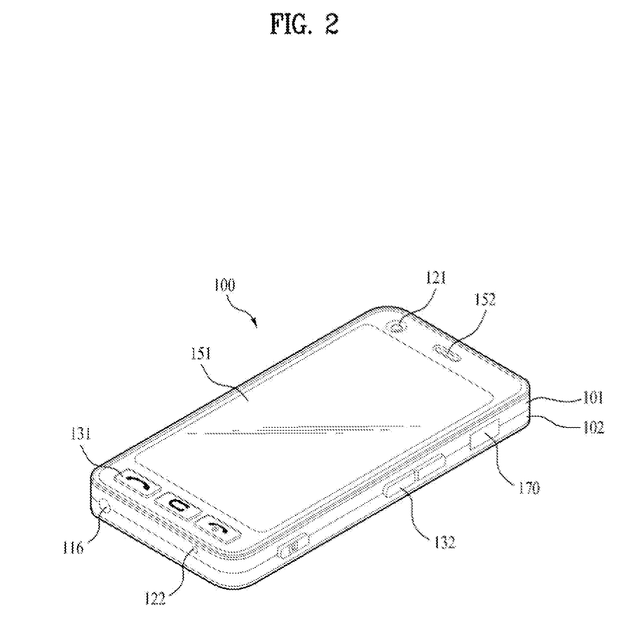

FIG. 2 is a front perspective diagram of a mobile terminal according to various embodiments of the present invention. The mobile terminal 100 is shown as a bar type terminal body, but the mobile terminal may alternative be implemented using other configuration such as folder-type, slide-type, rotational-type, swing-type, combinations thereof, and the like. For clarity, further disclosure will primarily relate to a bar-type mobile terminal 100, but such teachings apply equally to other types of mobile terminals.

Referring still to FIG. 2, the mobile terminal 100 includes a case (casing, housing, cover, etc.) configuring an exterior thereof. The case is shown divided into a front case 101 and a rear case 102. Various electric/electronic parts are positioned or otherwise located in a space or cavity provided between the front and rear cases 101 and 102. Optionally, at least one middle case can be further provided between the front and rear cases 101 and 102. The cases 101 and 102 may be formed by injection molding of synthetic resin or they can be formed of metal substance such as stainless steel (STS), titanium (Ti) or the like, for example.

A display 151, an audio output unit 152, a camera 121, user input units 130/131 and 132, a microphone 122, an interface 180 and the like can be provided to the terminal body, and more particularly, to the front case 101.

The display 151 is shown occupying the majority of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. The input unit 130 may also include a plurality of manipulating units 131 and 132. The manipulating units 131 and 132 will sometimes be referred to herein as a manipulating portion and they may implement any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. A command for volume adjustment of sound outputted from the audio output unit 152, a command for switching to a touch recognizing mode of the display 151 or the like can be inputted to the second manipulating unit 132.

For clarity and convenience of the following description, assume that a mobile terminal mentioned in the following description may include at least one of the components shown in FIG. 1. In particular, a mobile terminal according to the present invention may include a display unit 151, a wireless communication unit 110, a memory 160 and a controller 180.

For clarity and convenience of the following description, a terminal, which displays a full or partial image of a content provided by a mobile terminal on a screen, may be named an external terminal. In order to discriminate a display unit 151 of a mobile terminal and a display unit of an external terminal 200 from each other to prevent confusion in use, the display unit 151 of the mobile terminal may be named a 1^{st} display unit and the display unit of the external terminal 200 may be named a 2^{nd} display unit.

The 1^{st} display unit 151 displays a full or partial image of a content saved in the mobile terminal and outputs various kinds of menu screens under the control of the controller 180. A user may be provided with various kinds of visual informations as well as contents via the 1^{st} display unit 151. And, the user may watch the full or partial image of the content via the 1^{st} display unit 151 or may be provided with a menu screen for controlling overall operations of the mobile terminal.

The wireless communication unit 110 may be set to perform a communication with at least one external terminal 200. In particular, the wireless communication unit 110 may transmit a content saved in the memory 160 to the external terminal 200 and may receive display information of the external terminal 200.

In this case, the content may include at least one of an e-book, a webpage, an image, a video, a game and an e-document or may include at least one of thumbnails of the e-book, webpage, image, video, game and e-document. In particular, if such a thumbnail is used, it may be able to considerably reduce a communication data traffic between the wireless communication unit 110 and the external terminal 200. Hence, a communication load can be reduced and data transmission in-between can be performed at high sped.

The memory 160 stores various contents and may be able to store display information of the mobile terminal and display information of the external terminal 200 as well.

When a 1^{st} image 11 of a full image of a content is displayed on the 1^{st} display unit 151, the controller 180 may control a 2^{nd} image 12 different from the 1^{st} image 11 in the full image of the content to be displayed on the external terminal 200. In particular, the controller 180 may be able to control a full image of a single content to be outputted using the 1^{st} display unit 151 and a 2^{nd} display unit simultaneously.

In order for the 1^{st} display unit 151 and the external terminal 200 to output the 1^{st} image 11 and the 2^{nd} image 12, respectively, the controller 180 may control the content or the 2^{nd} image 12 to be transmitted to the external terminal 200. In order to control a display output of the external terminal 200, the controller 180 generates a control signal and may be then able to control the wireless communication unit 110 to transmit the generated control signal to the external terminal 200. Based on the control signal, the external terminal 200 may be then able to control an output of the 2^{nd} display unit.

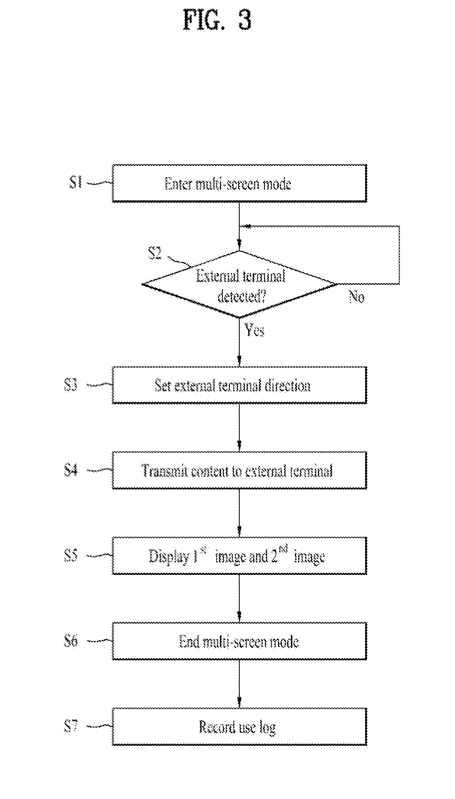

FIG. 3 is a flowchart for a method of controlling a mobile terminal according to one embodiment of the present invention.

Referring to FIG. 3, a multi-screen mode entering step S1 is the step that the controller 180 enters a multi-screen mode based on an external input.

Once the multi-screen mode is entered, the controller 180 may be set to detect an external terminal 200 [S2]. Using a radio frequency signal received from the external terminal 200, the controller 180 may be able to determine a presence (or non-presence) of the external terminal 200. In this case, the radio frequency signal may be transferred using such a short-range communication as WiFi Direct, Bluetooth, Zigbee, RFID, UWB, IrDA, NFC and the like, by which the present invention may be non-limited.

If the external terminal 200 is detected, the controller 180 may set a direction of the detected external terminal 200 manually or automatically [S3]. In particular, the controller 180 may be able to set the direction indicating which direction the external terminal 200 is located with reference to the 1^{st} display unit 151.

In order for the controller 180 to recognize the direction of the external terminal 200, various methods may be available. For one example of the direction recognizing method, after proximity sensors have been installed at four lateral sides of a case including the front and rear cases 101 and 102 assembled together, the controller 180 may be able to recognize the direction of the external terminal 200 in a manner of detecting whether a prescribed object is located on a prescribed detection plane using the installed proximity sensors.

For another example, if the mobile terminal is inclined toward a location of the external terminal 200, the controller 180 may be able to recognize the direction of the external terminal 200 in a manner of detecting the inclination of the mobile terminal through a sensor.

For further example, the controller 180 may be able to set a direction of the external terminal 200 in a manner of receiving an external user input.

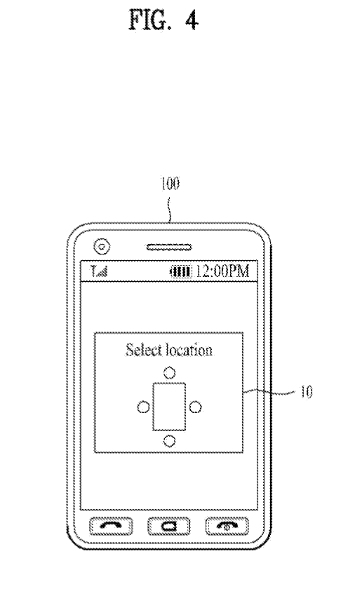

FIG. 4 is a diagram for one example of a screen provided to determine a direction of an external terminal manually.

Referring to FIG. 4, if the external terminal 200 is detected, the controller 180 may be able to provide a popup 10 for setting a direction of the external terminal 200. A user may be able to select a prescribed location at which the external terminal 200 is located with reference to the 1^{st} display 151 and the controller 180 may be then able to set the direction of the external terminal 200 via the corresponding user input. Moreover, if at least two external terminals 200 are detected, the controller 180 may be able to set directions for the at least two external terminals 200, respectively.

FIG. 4 shows that the location of the external terminal 200 may be set to one of 4 directions centering on the 1^{st} display unit 151, by which the present invention may be non-limited.

The above-mentioned methods of setting the direction of the external terminal 200 are non-limited by the above-mentioned examples and may further include various methods that may be easily devised by those skilled in the art to which the present invention pertains.

Once the direction of the external terminal 200 is set, the controller 180 transmits the content to the external terminal 200 via the wireless communication unit 110 [S4]. The controller 180 may then control a 2^{nd} image, which is different from a 1^{st} image in a full image of the content, to be displayed on the external terminal 200 while the 1^{st} image is being displayed on the 1^{st} display unit 151 [S5].

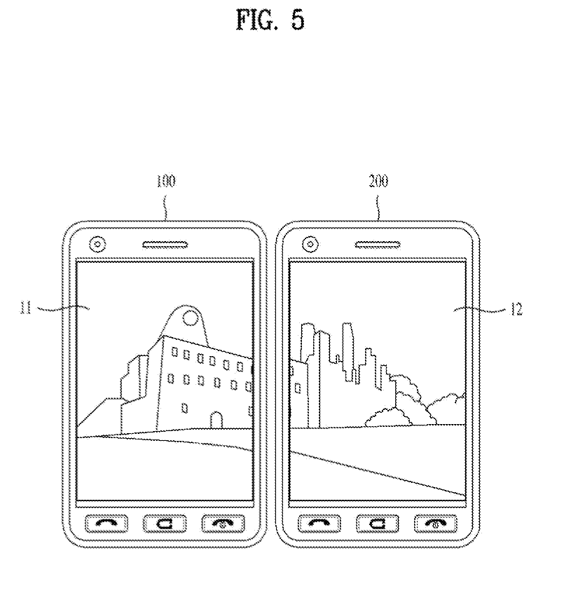

FIG. 5 is a diagram for one example to describe that a 1^{st} image and a 2^{nd} image are displayed on a 1^{st} display unit and an external terminal, respectively.

Referring to FIG. 5, assuming that a left part and a right part of the drawing correspond to the mobile terminal 100 and the external terminal 200, respectively, the mobile terminal 100 displays the 1^{st} image 11 in the full image of the content and may control the 2^{nd} image 12, which is different from the 1^{st} image 11 in the full image of the content, to be displayed on the external terminal 200.

In order to enable the external terminal 200 to display the 2^{nd} image 12, the controller 180 may transmit the full image of the content to the external terminal 200. Alternatively, the controller 180 partitions the full image of the content into the 1^{st} image 11 and the end image 12 and may be then able to transmit the 2^{nd} image 12 to the external terminal 200.

In case that the full image of the content is transmitted to the external terminal 200, the controller 180 may be able to generate a control signal to enable the external terminal 200 to display the 2^{nd} image 12 in the full image of the content. In this case, the control signal may include an information indicating that the external terminal 200 directs the 2^{nd} image 12 in the full image. The controller 180 may be able to control the wireless communication unit 110 to transmit the control signal to the external terminal 200. Subsequently, if the external terminal 200 receives the control signal, it may be able to set the 2^{nd} image in the full image of the received content to be displayed.

In case that the full image of the content is partitioned into the 1^{st} image 11 and the 2^{nd} image 12 and the 2^{nd} image 12 is then transmitted to the external terminal 200, the controller 180 may be able to generate a control signal for commanding the received 2^{nd} image 12 to be displayed. If the external terminal 200 receives the control signal, the external terminal 200 may be able to display the 2^{nd} image 12 on the screen.

In particular, the 2^{nd} image in the full image of the content may be controller to be displayed on the external terminal 200 using the control signal generated by the controller 180.

In doing so, the controller 180 may be able to determine a method of partitioning the full image of the content in accordance with a direction of the external terminal 200. For instance, if the external terminal 200 is located at a top or bottom side of the 1^{st} display unit 151, the controller 180 may be able to configure the 1^{st} image 11 and the end image 12 by partitioning the full image of the content into a top and a bottom. In case that the external terminal 200 is located at a right or left side of the 1^{st} display unit 151, the controller 180 may be able to configure the 1^{st} image 11 and the 2^{nd} image 12 by partitioning the full image of the content into a left part and a right part, as shown in FIG. 5.

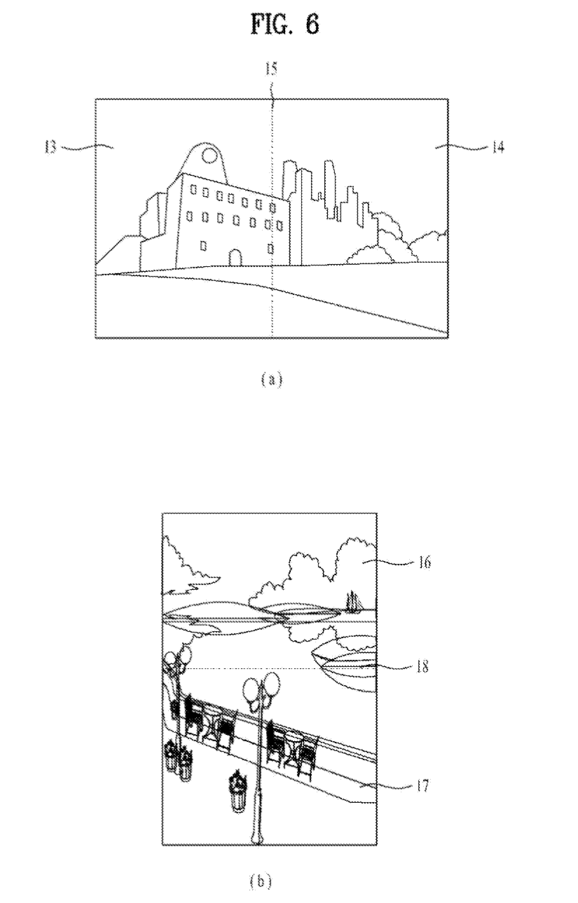

FIG. 6A and FIG. 6B are diagrams for examples to describe that a 1^{st} image and a 2^{nd} image are configured by partitioning a full image of each content into right & left parts or top & bottom parts.

Referring to FIG. 6A, a full image of a content may be separated into a 1^{st} image 13 and a 2^{nd} image 14 with reference to a dotted line 15 by being partitioned into a left part and a right part. Alternatively, referring to FIG. 6B, a full image of a content may be separated into a 1^{st} image 16 and a 2^{nd} image 17 with reference to a dotted line 18 by being partitioned into a top part and a bottom part.

In this case, the controller 180 may be able to control the full image of the content to be transmitted to the external terminal 200 or may be able to control the 2^{nd} image 14 in the full image of the content to be transmitted to the external terminal 200. By controlling a control signal to be transmitted to the external terminal 200, the controller 180 may be able to control the external terminal 200 to display the 2^{nd} image 14 in the full image of the content.

In this case, the doted line 15/18 shown in FIG. 6A/6B is just shown to indicate the boundary between the 1^{st} image and the 2^{nd} image and may not be actually displayed on the full image.

According to the present embodiment, the full image of the content is partitioned into 2 images on the assumption that one external terminal 200 exists only, by which the present invention may be non-limited. For example, in case that a plurality of external terminals 200 are connected to the mobile terminal, the controller 180 may be able to determine a partitioning count of the full image of the content in consideration of the number of the external terminals 200.

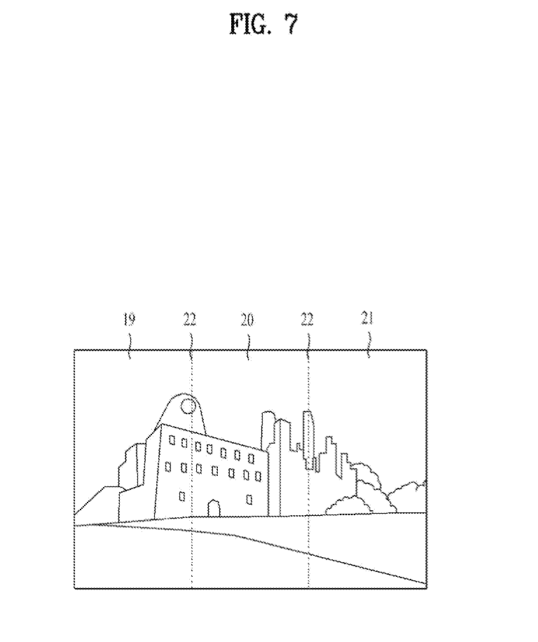

FIG. 7 is a diagram for one example to describe that 1^{st} to 3^{rd} images are configured by partitioning a full image of a content if two external terminals are present.

Referring to FIG. 7, if 2 external terminals 200 are connected to the mobile terminal 100, a full image of a content is partitioned twice into a 1^{st} image 19, a 2^{nd} image 20 and a 3^{rd} image 21 with reference to dotted lines 22.

Subsequently, the controller 180 may be able to control the full image of the content to be transmitted to the 2 external terminals 200.

The controller 180 may be able to transmit a control signal including an information indicating a 2^{nd} region of the full image of the content or an information indicating a 3^{rd} region of the full image of the content or a control signal for controlling the received 2^{nd} image 20 or the 3^{rd} image 21 to be displayed to each of the external terminals 200. Each of the external terminals 200 may be then able to display the 2^{nd} image 20 or the 3^{rd} image 21 by receiving the corresponding control signal.

Like the case shown in FIG. 6, the dotted lines 22 shown in FIG. 7 are just provided to indicate the boundaries between the 1^{st} to 3^{rd} images and may not be actually displayed on the full image of the content.

According to another embodiment of the present invention, the controller 180 may be able to control the 1^{st} display unit 151 or the external terminal 200 to display a screen rotated by 180 degrees.

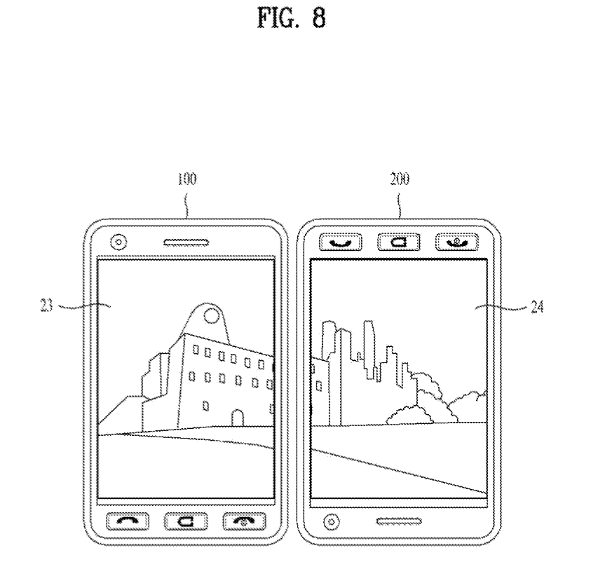

FIG. 8 is a diagram for one example that a display unit outputs a 180-degree rotated screen. Referring to FIG. 8, in case that the external terminal 200 is placed neighbor to the mobile terminal 100 in a manner of being rotated by 180 degrees, the controller 180 may be able to control either a 1^{st} image 23 or a 2^{nd} image 24 to be outputted in a manner of being rotated by 180 degrees. The controller 180 may be able to control the display unit to output the 1^{st} image 23 that is rotated. And, the controller 180 may be able to control the external terminal 200 to display the 2^{nd} image 24 rotated by 180 degrees using a control signal.

If the controller 180 receives a status information, which indicates that the external terminal 200 is rotated, from the external terminal 200, the controller 180 may be able to control either the 1^{st} image 23 or the 2^{nd} image 24 to be rotated by 180 degrees. If the controller 180 receives a user input to rotate either the 1^{st} image 23 or the 2^{nd} image 24 by 180 degrees, the controller 180 may be able to control either the 1^{st} image 23 or the 2^{nd} image 24 to be rotated by 180 degrees.

By outputting either the 1^{st} image 23 or the 2^{nd} image 24 rotated by 180 degrees, a user may be able to place the mobile terminal 100 and the external terminal 200 to enable the bezels between the 1^{st} display unit 151 and the 2^{nd} display unit to have a minimum width in consideration of bezel widths of the mobile terminal 100 and the external terminal 200.

Based on a user input, the controller 180 may end the multi-screen mode. Alternatively, if a prescribed event takes place in the mobile terminal 100 or a wireless communication strength of the external terminal 200 is lowered below a prescribed level, the controller 180 may set the multi-screen mode to be ended [S6].

For instance, if a strength of a radio frequency signal received from the external terminal 200 is equal to or lower than a predetermined value, the controller 180 may set the multi-screen mode to be ended.

Alternatively, while the multi-screen mode is active, if an event takes place in the mobile terminal 100 or the external terminal 200, the controller 180 may set the multi-screen mode to be ended.

For instance, while the multi-screen mode is active, if a call signal is received via the wireless communication unit 110 or such a message as SMS, LMS, MMS, IM and the like is received, the controller 180 may be able to end the multi-screen mode.

In case that the multi-screen mode is ended, the controller 180 generates a use log and may be then able to save to use log in the memory 160 [S7]. In this case, the use log may include information on a most recently displayed image or the like. When the multi-screen mode is activated again, the controller 180 may control a last displayed image to be outputted to the 1^{st} display unit 151 and the external terminal 200 based on the use log.

In the step S5 of outputting the 1^{st} image and the 2^{nd} image, the controller 180 may be able to control an output of the 1^{st} display unit 151 or the 2^{nd} display unit in consideration of the specifications of the 1^{st} display unit 151 and the specifications of the 2^{nd} display unit.

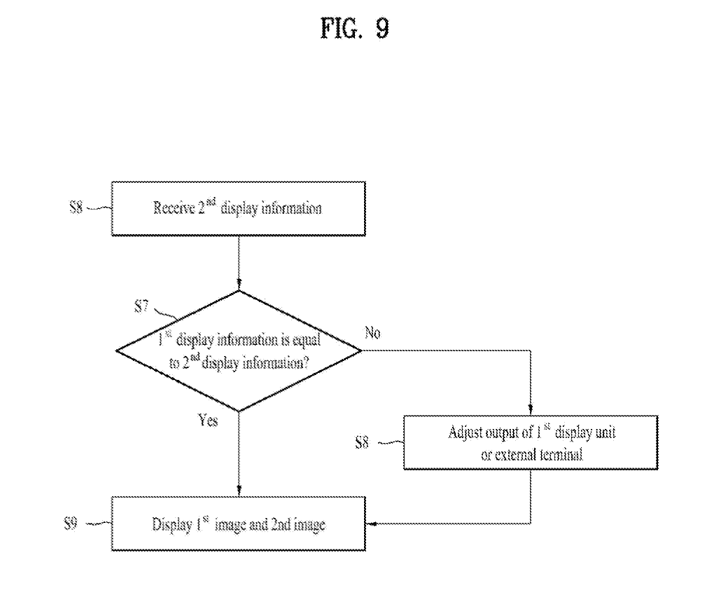

FIG. 9 is a detailed flowchart of the step of displaying 1^{st} and 2^{nd} images shown in FIG. 3.

Referring to FIG. 9, the controller 180 may control the wireless communication unit 110 to receive a display information (hereinafter named a 2^{nd} display information) of the 2^{nd} display unit from the external terminal 200 [S8]. In this case, the display information relates to the specifications of the display and may include a screen size, a screen resolution, a screen brightness and the like, by which the present invention may be non-limited.

The controller 180 compares a display information (hereinafter named a 1^{st} display information) with the 2^{nd} display information [S7] and may be able to control an output of the 1^{st} display unit 151 or the external terminal 200 in accordance with a result of the comparison [S8, S9].

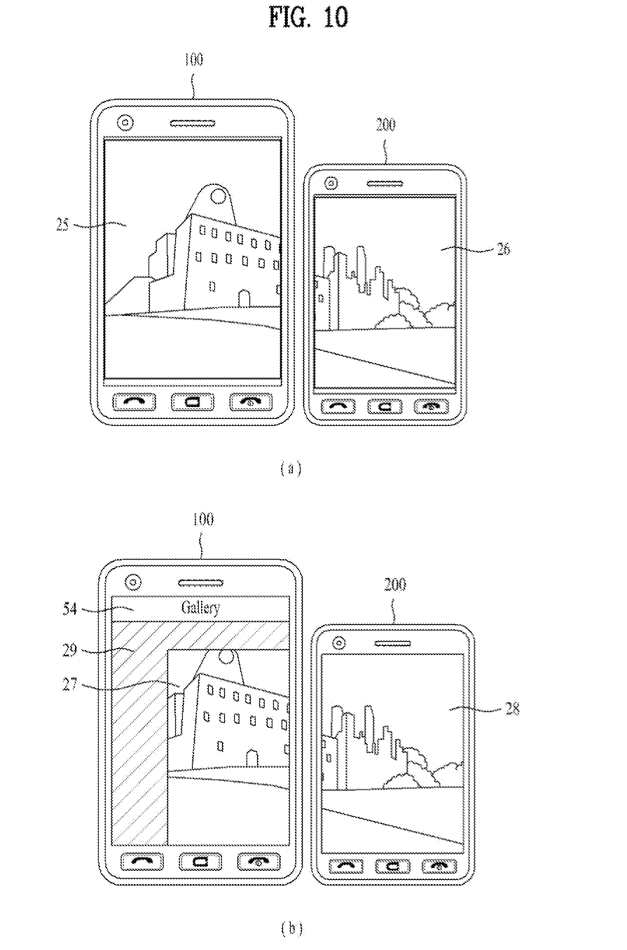

For instance, FIG. 10A and FIG. 10B are diagrams for one example that a 1^{st} image and a 2^{nd} image are outputted to a 1^{st} display unit and a 2^{nd} display unit differing from each other in screen size. Referring to FIG. 10A, if a screen size of the 1^{st} display unit 151 is larger than that of the 2^{nd} display unit, as a size of a 1^{st} image 25 displayed on the 1^{st} display unit 151 is larger than that of a 2^{nd} image 26 displayed on the 2^{nd} display unit, it may cause a sense of difference between the 1^{st} image 25 and the 2^{nd} image 26.

Therefore, the controller 180 compares the screen size of the 1^{st} display unit 151 with the screen size of the 2^{nd} display unit and may be then able to control the sizes of the 1^{st} and 2^{nd} images 25 and 26 to be adjusted in accordance with a smaller screen size in-between.

FIG. 10B is a diagram for one example to describe that a 1^{st} display unit and an external terminal display the 1^{st} image and the 2^{nd} image equal to each other in size, respectively. Referring to FIG. 10B, the controller 180 may be able to set a size of the 1^{st} image 27, which is displayed on the 1^{st} display unit 151, to be equal to a screen size of the 2^{nd} display unit. Thus, the controller 180 may be able to control the 1^{st} image 27 and the 2^{nd} image 28 to be displayed in equal size. In doing so, the controller 180 may be able to control the 1^{st} image 27 to be displayed on the 1^{st} display unit 151 in a manner of being partial to a side toward the external terminal 200.

Therefore, if the 1^{st} image 27 and the 2^{nd} image 28 are displayed in equal size and the 1^{st} image 27 is displayed by being partial to the side toward the external terminal 200, it may be able to minimize the sense of difference generated from the boundary between the 1^{st} image 27 and the 2^{nd} image 28.

According to another embodiment of the present invention, based on an external input, the controller 180 may be able to adjust a displayed size of a 1^{st} image and a displayed size of a 2^{nd} image. If a user adjusts the sizes of the 1^{st} and 2^{nd} images manually, it may be able to minimize the sense of difference generated from the boundary between the 1^{st} image and the 2^{nd} image due to the screen size difference between the 1^{st} display unit 151 and the 2^{nd} display unit.

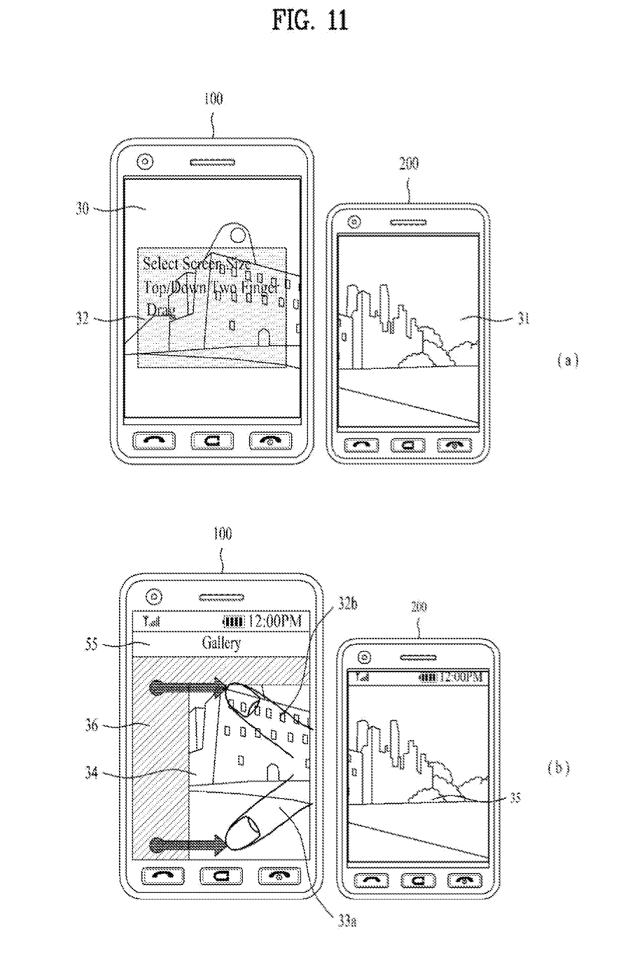

FIG. 11A and FIG. 11B are diagrams for one example of screens provided to adjust sizes of 1^{st} and 2^{nd} images outputted via a 1^{st} display unit and an external terminal, respectively. Referring to FIG. 11A, the controller 180 may provide a user with a popup screen 32 for designating a size of a 1^{st} image 30 displayed via the 1^{st} display unit 151. Referring to FIG. 11B, while the user touches top and bottom parts of the display unit with two pointers 33a and 33b, if the user drags the two pointers 33a and 33b in a horizontal direction, it may be able to designate a height difference between the dragged pointers 33a and 33b to a height of the 1^{st} image 34.

In accordance with the height set using the pointers, the controller 180 adjusts the height of the 1^{st} image 34 outputted from the 1^{st} display unit 151 and may be able to adjust a width of the 1^{st} image 34 in proportion to the height of the adjusted 1^{st} image 34. In doing so, the controller 180 may be able to control a 2^{nd} image 35 outputted from the external terminal 200 to be displayed to the same height of the 1^{st} image 34. In order to adjust the 2^{nd} image 35 to have the same size of the 1^{st} image 34, the controller 180 generates a control signal and may be then able to transmit the generated control signal to the external terminal 200.

Referring now to FIG. 10B or FIG. 11B, if the size of the 1^{st} image displayed on the 1^{st} display unit 151 is adjusted smaller than that of the 1^{st} display unit 151, it may generate a screen blank 29/36, in which the 1^{st} image is not displayed, from the 1^{st} display unit 151. The controller 180 may control an indicator 54/55, which indicates an operating status of the mobile terminal, to be displayed in the screen blank 29/36 and may also control a black image, a white image or a grid pattern to be displayed on the rest. Instead of outputting the indicator 54/55 to the screen blank 29/36, the controller 180 may control a black or white image to be outputted to the screen blank 29/36 or may control a grid pattern to be outputted to the screen blank 29/36. In this case, the indicator 54/55 may indicate the operating status of the mobile terminal 100. For instance, if the mobile terminal 10 displays an image content, the indicator 54/55 may be able to indicate that an image viewing program is active [e.g., ‘gallery’ shown in FIG. 10B/11B]. For another instance, if the content is an e-book, the indicator 54/55 may indicate that an e-book reader program is active. If the content is a webpage, the indicator 54/55 may indicate that a web browser is active. For further instance, the controller 180 displays ‘multi-screen mode’ (e.g., ‘screen partition mode’, ‘wide screen mode’, etc.) on the indicator 54/55 to indicate that the mobile terminal 100 is operating in the multi-screen mode.

Moreover, in case that a screen resolution of the 1^{st} display unit 151 is different from a screen resolution of the 2^{nd} display unit, the controller 180 may be able to control screen resolutions of the display unit and the external terminal 200 to be adjusted with reference to a low resolution. For instance, if the resolutions of the 1^{st} display unit 151 and the 2^{nd} display unit are set to 1024*768 and 800*600, respectively, the controller 180 may be able to adjust an output resolution of the 1^{st} display unit 151 with reference to the 800*600 that is the low resolution. Through this, the controller 180 may control the 1^{st} image and the 2^{nd} image to be outputted at the same screen resolution, whereby the sense of difference generated between the 1^{st} image and the 2^{nd} image can be minimized. In case of attempting to adjust the screen resolution of the external terminal 200, the controller 180 generates a control signal and then transmits the generated control signal to the external terminal 200, thereby enabling the screen resolution of the external terminal 200 to be adjusted.

For another instance, if a screen brightness of the 1^{st} display unit 151 is different from that of the 2^{nd} display unit, the controller 180 may be able to adjust the screen brightness of the 1^{st} display unit 151 and the screen brightness of the external terminal 200 with reference to the higher or lower screen brightness of the two. For example, if the screen brightness of the 1^{st} display unit 151 is Level 5 and the screen brightness of the 2^{nd} display unit is Level 7, the controller 180 may adjust the brightness of the 1^{st} display unit 151 into a higher level, i.e., Level 7, or may adjust the brightness of the 2^{nd} display unit into a lower level, i.e., Level 5.

According to the above-described embodiment, after a single content has been partitioned into a 1^{st} image and a 2^{nd} image, the 1^{st} display unit 151 and the external terminal 200 display the 1^{st} image and the 2^{nd} image, respectively.

According to another embodiment of the present invention, the controller 180 may be able to control a full image of a 1^{st} content to be displayed on the 1^{st} display unit 151 and may be also able to control a full image of a 2^{nd} content, which is different from the 1^{st} content, to be displayed on the external terminal 200 at the same time.

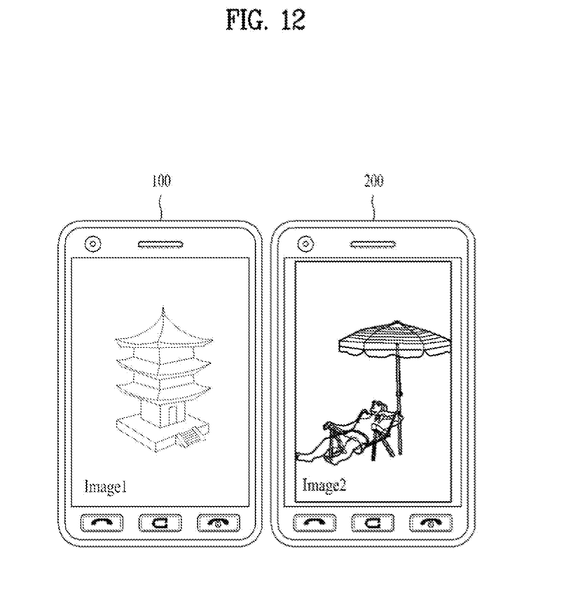

FIG. 12 is a diagram for one example that a 1^{st} display unit and an external terminal display a full image of a 1^{st} content and a full image of a 2^{nd} content, respectively.

Referring to FIG. 12, the controller 180 may be able to control the 1^{st} display unit 151 and the external terminal 200 to display full images Image 1 and Image 2 of different contents, respectively.

For clarity and convenience of the following description, if the 1^{st} display unit 151 and the external terminal 200 are set to display a 1^{st} image, which is a portion of a full image of a single content, and a 2^{nd} image different from the 1^{st} image, respectively, such a mode shall be named ‘wide screen mode’. If the 1^{st} display unit 151 and the external terminal 200 are set to display a full image of a 1^{st} content and a full image of a 2^{nd} content, respectively, such a mode shall be named ‘screen partition mode’. And, it may be understood that the aforesaid multi-screen mode includes both of the wide screen mode and the screen partition mode.

After the controller 180 has entered the multi-screen mode, it may be able to further include the step of setting modes of the 1^{st} display unit and the external terminal to either the wide screen mode or the screen partition mode after completion of a random one of the steps S1 to S3.

While the 1^{st} display unit 151 and the external terminal 200 are displaying prescribed images in the wide screen mode or the screen partition mode, respectively, the controller 180 may be able to perform various control operations based on a user input. In the following description, while prescribed images are displayed via the 1^{st} display unit 151 and the external terminal 200, various embodiments performed on the basis of a user input by the controller 180 are explained.

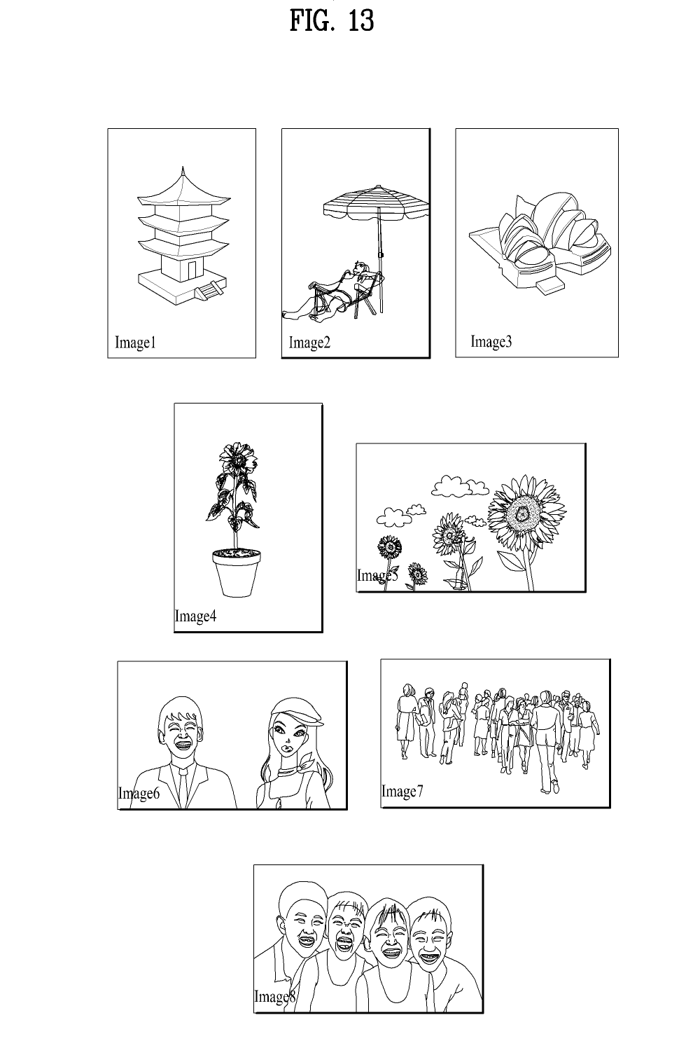

For clarity and convenience of the following description, contents Image 1 to Image 8 exemplarily shown in FIG. 13 shall be taken as examples for the description of the screen partition mode. FIG. 13 is a diagram for one example of contents saved in the memory 160. In this case, the texts of Image 1 to Image 8 displayed on full images of the contents are randomly given to identify the corresponding contents, respectively and may not be actually contained in the content images, respectively.

### 1^{st} Embodiment

First of all, the controller 180 may be able to adjust a display mode of the 1^{st} display unit 151 into a landscape mode or a portrait mode.

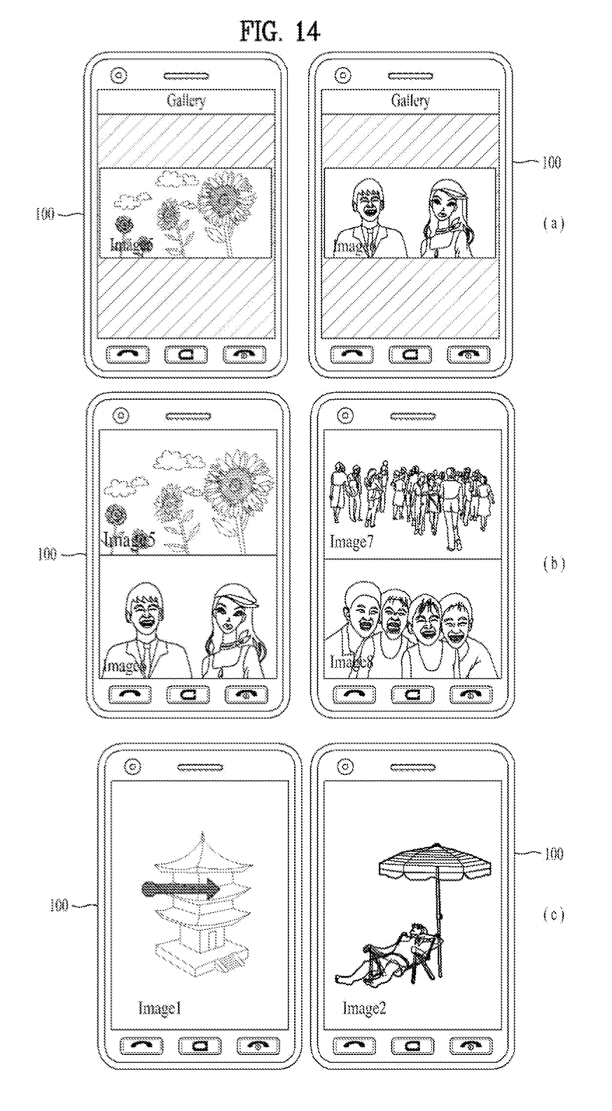

FIGS. 14A to 14C are diagrams for one example of a case that a display mode of a mobile terminal in a screen partition mode is set to a landscape mode.

Referring to FIG. 14A, if the display unit 151 outputs a landscape image (e.g., one of Image 5 to Image 8 shown in FIG. 13) having an image width greater than an image height, the controller 180 may output a landscape image to a center of the 1^{st} display unit 151. The controller 180 displays an indicator (i.e., ‘gallery’ shown in FIG. 14A) indicting an operating status of the mobile terminal 100 on a blank of the screen and may control a black image, a white image or a grid pattern to be outputted to the rest of the screen. Alternatively, the controller 180 does not output the indicator to the screen blank but may control a black image, a white image or a grid pattern to be outputted to the screen blank.

Referring to FIG. 14B, the controller 180 may be able to control a plurality of landscape images to be outputted from the 1^{st} display unit 151. Although FIG. 14B shows that two landscape images are displayed on each of the 1^{st} display unit 151 and an external terminal, more landscape images can be set to be simultaneously outputted.

Referring to FIG. 14C, in case that the 1^{st} display unit 151 outputs a portrait image (e.g., one of Image 1 to Image 4 shown in FIG. 13) having an image height greater than an image width, the controller 180 may be able to control portrait images to be outputted as full screens from the 1^{st} image 151 and the external terminal 200, respectively.

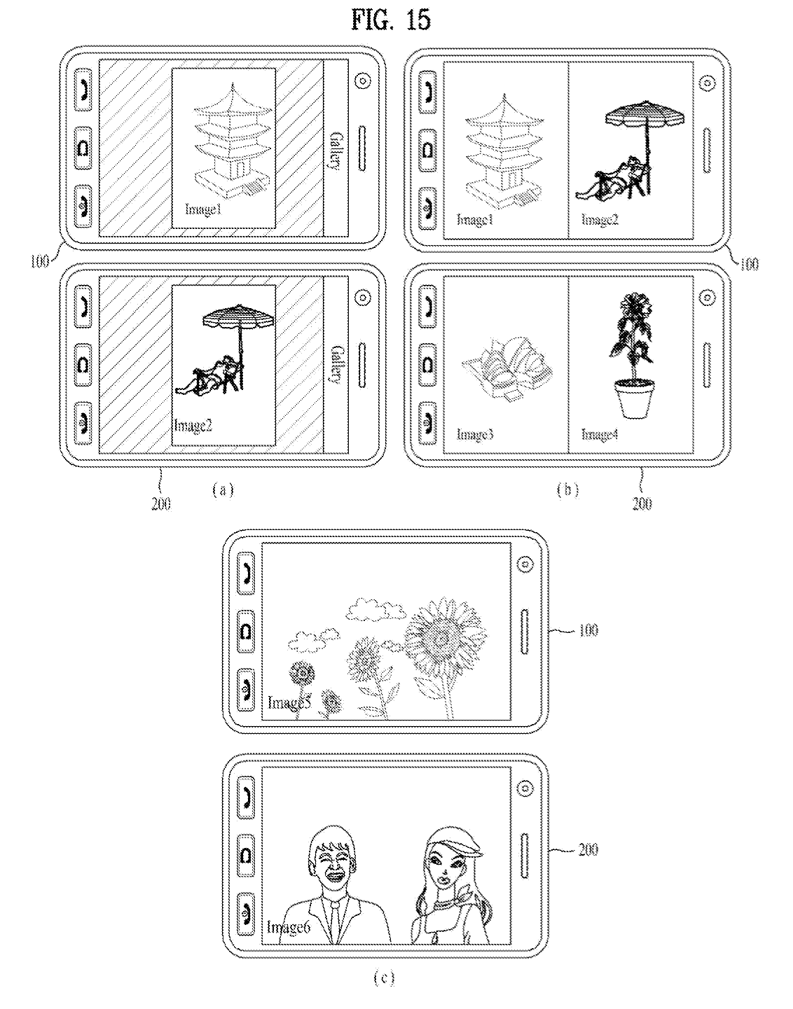

FIGS. 15A to 15C are diagrams for one example of a case that a display mode of a mobile terminal in a screen partition mode is set to a portrait mode.

Referring to FIG. 15A, if the display unit 151 outputs a portrait image, the controller 180 may output a portrait image to a center of the 1^{st} display unit 151. The controller 180 displays an indicator (i.e., ‘gallery’ shown in FIG. 15A) indicting an operating status of the mobile terminal 100 on a screen blank 28 and may control a black image, a white image or a grid pattern to be outputted to the rest of the screen. Alternatively, the controller 180 does not output the indicator to the screen blank but may control a black image, a white image or a grid pattern to be outputted to the screen blank.

Referring to FIG. 15B, the controller 180 may be able to control a plurality of landscape images to be outputted from the 1^{st} display unit 151 and the external terminal 200.

Referring to FIG. 15C, in case that the 1^{st} display unit 151 and the external terminal 100 output landscape images, respectively, the controller 180 may be able to control the landscape images to be outputted as full screens from the 1^{st} image 151 and the external terminal 200, respectively.

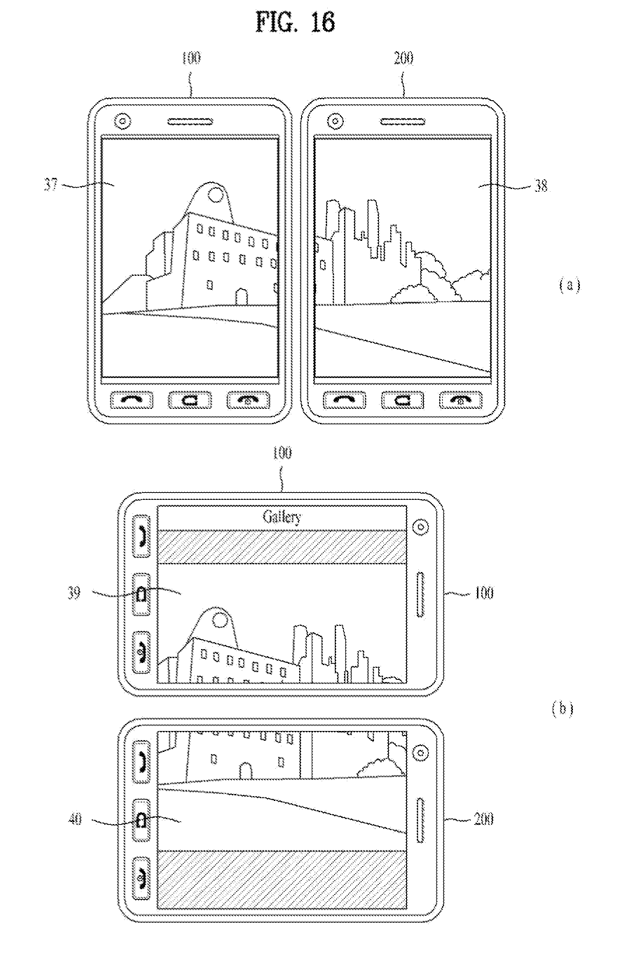

FIG. 16A and FIG. 16B are diagrams for one example of a case that a display mode of a mobile terminal in a wide screen mode is set to a portrait mode or a landscape mode.

Referring to FIG. 16A, in case that a display mode of the mobile terminal 100 is set to a portrait mode, a full image of a content is partitioned into a left image and a right image to configure a 1^{st} image 37 and a 2^{nd} image 38. The controller 180 may be able to control the 1^{st} display unit and the external terminal 200 to display the 1^{st} image 37 and the 2^{nd} image 38, respectively.

Referring to FIG. 16B, while the 1^{st} and 2^{nd} images 37 and 38 are displayed, if each of the mobile terminal 100 and the external terminal 200 enters a landscape mode, the full image of the content is partitioned into a top image and a bottom image to configure a 1^{st} image 39 and a 2^{nd} image 40. And, the controller 180 may be able to transmit a control signal indicating the new 2^{nd} image 40 or a control signal, which indicates that the 2^{nd} image 40 is changed, to the external terminal 200.

FIGS. 14 to 16 just show the examples of the image displaying method in the landscape mode and/or the portrait mode, by which the present invention may be non-limited. And, various modifications can apply as well as the corresponding drawings.

The controller 180 may be able to freely adjust the display mode of the 1^{st} display unit 151 between the landscape mode and the portrait mode. In doing so, the landscape mode and the portrait mode can be switched to each other in various ways. For instance, the controller 180 may be able to set the display mode of the 1^{st} display unit 151 to the landscape mode or the portrait mode through such an external input as a case of rotating the mobile terminal by a prescribed angle, a case of drawing a pre-designated diagram on the 1^{st} display unit 151 using a pointer, a case of quickly touching one of four sides of the 1^{st} display unit 151 with a pointer at least twice, and the like.

In doing so, the controller 180 may be able to control the external terminal 200 to operate in the same display mode of the 1^{st} display unit 151. In particular, if the display mode of the 1^{st} display unit 151 is switched to the portrait mode from the landscape mode, the controller 180 controls the display mode of the external terminal 200 to be set to the portrait mode. If the display mode of the 1^{st} display unit 151 is switched from the portrait mode to the landscape mode, the controller 180 controls the display mode of the external terminal 200 to be set to the landscape mode.

### 2^{nd} Embodiment

First of all, the controller 180 may be able to control images outputted by the 1^{st} display unit 151 and the external terminal 200 to be switched to new images, respectively, based on an external input. For instance, if a pointer 19 is flicked left to right by having the pointer closely contact with the 1^{st} display unit 151, the controller 180 may be able to control an image related to a next content to be outputted from the 1^{st} display unit 151 and the external terminal 200. If the pointer 19 is flicked right to left, the controller 180 may be able to control an image related to a previous content to be outputted to the 1^{st} display unit 151 and the external terminal 200.

In this case, a content next/previous to a prescribed content may be determined based on sorting contents saved in the memory 160 by ascending/descending order of file names or file created dates of the contents, by which the present invention may be non-limited.

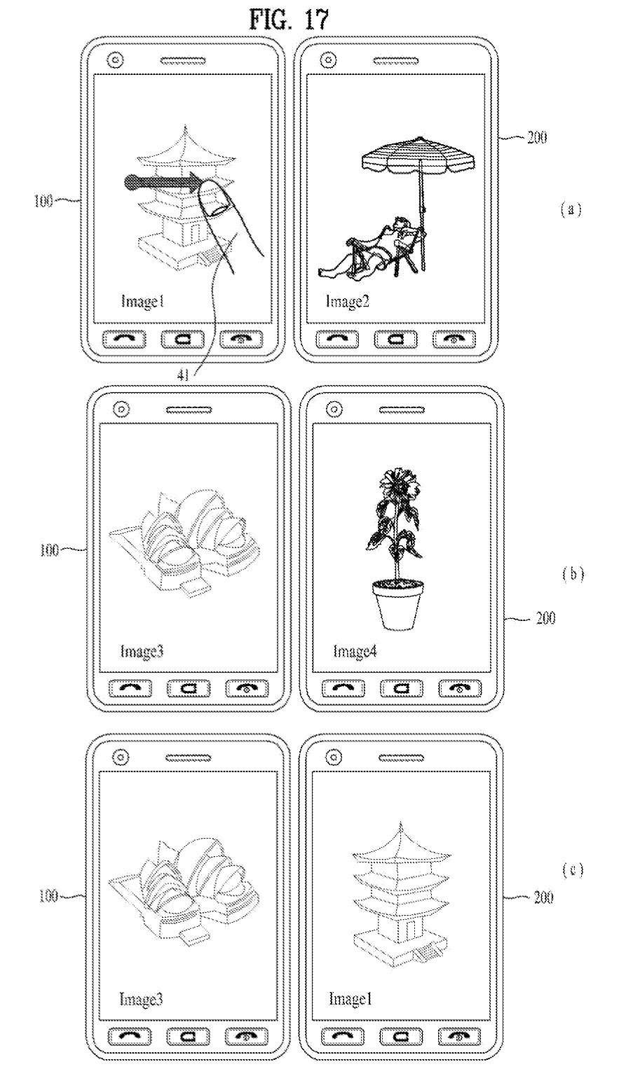

FIGS. 17A to 17C are diagrams for one example that a 1^{st} display unit and an external terminal are controlled to display a next or previous image in accordance with an external input in case of operation in a screen partition mode.

Referring to FIGS. 17A to 17C, while the 1^{st} display unit 151 and the external terminal 200 are displaying a 1^{st} image Image 1 and a 2^{nd} image Image 2, respectively, if a pointer 41 closely contacting with the 1^{st} display unit 151 is flicked left to right [FIG. 17A], the controller 180 may be able to control the 1^{st} display unit 151 and the external terminal 200 to display a 3^{rd} image Image 3 and a 4^{th} image Image 4, respectively [FIG. 17B]. Alternatively, the controller 180 controls the 1^{st} display unit 151 to output the 3^{rd} image Image 3 and may control the external terminal 200 to output the 1^{st} image Image 1 used to be outputted from the 1^{st} display unit 151 [FIG. 17C]. In particular, the controller 180 may be able to control both of the 1^{st} display unit 151 and the external terminal 200 to output new images, respectively [FIG. 17B]. Alternatively, the controller 180 may be able to control either the 1^{st} display unit 151 or the external terminal 200 to output a new image [FIG. 17C].

In this case, if the pointer 24 is flicked right to left, the controller 180 may control the 1^{st} display unit 151 and the external terminal 200 to return to the states shown in FIG. 17A.

According to the present embodiment, if a user flicks the 1^{st} display unit 151 with a pointer, a next image or a previous image can be outputted, by which the present invention may be non-limited. For instance, if a user flicks the external terminal 200 (particularly, the 2^{nd} display nit of the external terminal 200) with a pointer, the user may be able to control a next image or a previous image to be outputted. In doing so, the controller 180 may be able to control outputs of the 1^{st} display nit 151 and the external terminal 200 by receiving a user input information corresponding to a user input from the external terminal 200. In particular, in response to the reception of the user input information, the controller 180 controls the 1^{st} display unit 151 to output a next or previous image and may be able to control a content and a control signal to be transmitted to the external terminal 200.

According to the present embodiment, the previous or next image is controlled to be outputted via the pointer 41, which is provided to facilitate the description of the present invention. This may non-limit the present invention. For example, based on various user inputted devised by those skilled in the art to which the present invention pertains, it may be able to control a next image or a previous image to be outputted.

### 3^{rd} Embodiment

First of all, according to the 2^{nd} embodiment, based on an external input, the controller 180 may control images, which are outputted from the 1^{st} display unit 151 and the external terminal 200, to be switched to new images, respectively. In doing so, while the output of the 1^{st} display unit 151 is fixed, the controller 180 may be able to control the 1^{st} display unit 151 and the external terminal 200 to switch the image displayed on the external terminal 200 to a new image only.

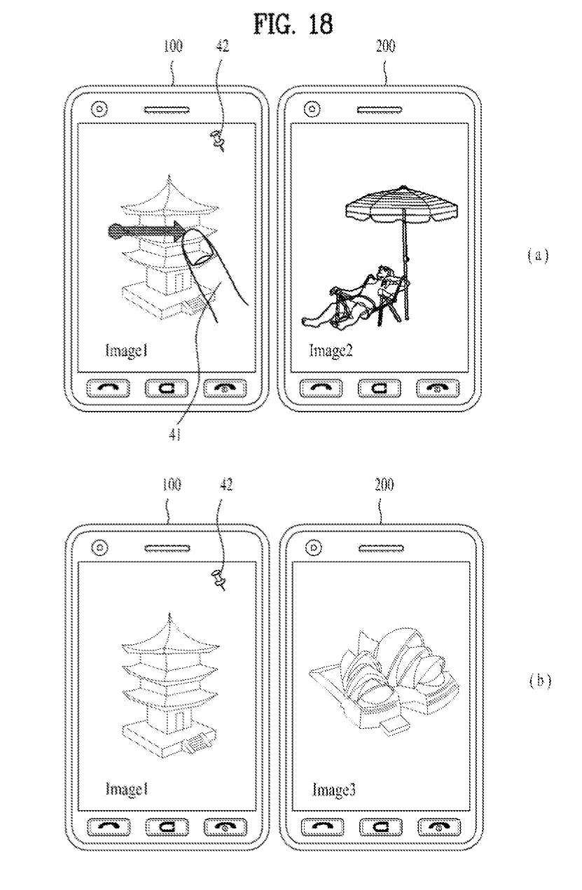

FIG. 18A and FIG. 18B are diagrams for one example of a screen provided to a user to fix an output of a 1^{st} display unit.

Referring to FIG. 18A, while the 1^{st} display unit 151 outputs a 1^{st} image Image 1 and the external terminal 20 outputs a 2^{nd} image Image 2, if a proximity touch (or a contact touch) is performed on a right top portion of the 1^{st} display unit 151 using a pointer 41, the controller 180 may be able to control a semi-transparent clip icon 42 to be displayed. If the clip icon 42 is contact-touched (or contact-touched again) with the pointer 41, the controller 180 may control the clip icon 42 to be fixedly displayed on the 1^{st} display unit 151 and may be able to control the 1^{st} image, which is outputted via the 1^{st} display unit 151, to be fixedly displayed.

Referring to FIG. 18B, while the 1^{st} display unit 151 is fixedly outputting the 1^{st} image, if the 1^{st} display unit 151 is flicked left to right with the pointer 41, the controller 180 may control the 1^{st} display unit 151 to keep outputting the 1^{st} image intact but may set the external terminal 200 to output a 3^{rd} image Image 3 that is a next image. In this case, if a flicking with the pointer 41 is performed in opposite direction, the controller 180 may control the 1^{st} display unit 151 to output the 1^{st} image intact but control the external terminal 200 to output a 2^{nd} image.

According to the present embodiment the 1^{st} display unit 151 is set to output an image fixedly but an output of the external terminal 200 is changeable in accordance with a user input, by which the present invention may be non-limited. On the other hand, the controller 180 may control an output of the 1^{st} display unit to be changed but control an output of the external terminal 200 to be fixed. If the controller 180 receives a fix setting signal, which indicates that the output of the external terminal 200 is fixed, from the external terminal 200 via the wireless communication unit, the controller 180 may be able to control the external terminal 200 to keep outputting the 2^{nd} image.

If the output of the external terminal 200 is released from the fixed state, the controller 180 may receive a fix release signal from the external terminal 200. In this case, as mentioned in the foregoing description of the 2^{nd} embodiment, the controller 180 may control the external terminal 200 to output a next image or a previous image based on a user input. In particular, the controller 180 generates a control signal and then transmits the generated control signal to the external terminal 200, thereby controlling an output of the external terminal 200. Moreover, it is a matter of course that outputs of the 1^{st} display unit 151 and the external terminal 200 may be set to be fixed as well.

According to the present embodiment, the output of the 1^{st} display unit is controlled to be fixed using the pointer. This facilitates the description of the present invention but may non-limit the present invention. Based on various user inputs devised by those skilled in the art to which the present invention pertains, an output of the 1^{st} display unit 151 may be fixed and an output of the external terminal 200 may be further fixed as well.

### 4^{th} Embodiment

First of all, in case that an image provided via the 1^{st} display unit 151 and the external terminal 200 is based on a thumbnail of a prescribed content, the controller 180 may control an original content file to be transmitted to the external terminal 200.

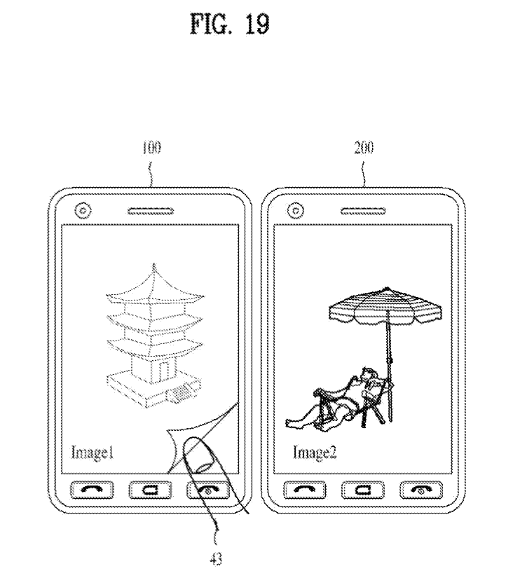

FIG. 19 is a diagram for one example of a user interface (UI) provided to a user to receive an original content.

Referring to FIG. 19, regarding a 1^{st} display having a thumbnail image displayed thereon, if a proximity touch (or a contact touch) is performed on a right bottom portion of the 1^{st} display, the controller 180 may be able to control an interactive effect (e.g., an effect as if a paper is rolled up) to be generated in response to the proximity touch. Subsequently, if a contact touch (or another contact touch) is performed on the interactive effect generated point using a pointer 43, the controller 180 may control the wireless communication unit 110 to transmit an original content to the external terminal 200.

The same interactive effect may be generated from the external terminal 200. If the interactive effect generated point is contact-touched via the external terminal 200, the wireless communication unit 110 may receive a transmission request signal from the external terminal 200. In doing so, the controller 180 may control the wireless communication unit 110 to transmit the original content to the external terminal 200 in response to the transmission request signal.

According to the present embodiment, the interactive effect is generated to facilitate the description of the present invention for example, by which the present invention may be non-limited.

### 5^{th} Embodiment

First of all, while the 1^{st} display unit 151 and the external terminal 200 are displaying different images, respectively, if an event occurs in the mobile terminal, the controller 180 transfers a partial or full image of a content outputted from the 1^{st} display unit 151 to the external terminal 200 and may control the full image of the content to be outputted from the external terminal 200.

In this case, the event may mean a case that the controller 180 is switched to a phone module in response to a call signal reception via the wireless communication unit 110 and that a screen corresponding to the phone module is outputted to the 1^{st} display unit 151 or a case that the controller 180 is switched to a message module in response to a reception of such a message as SMS, LMS, MMS, IM and the like via the wireless communication unit 110 and that an activated screen of the message module is outputted to the 1^{st} display unit 151.

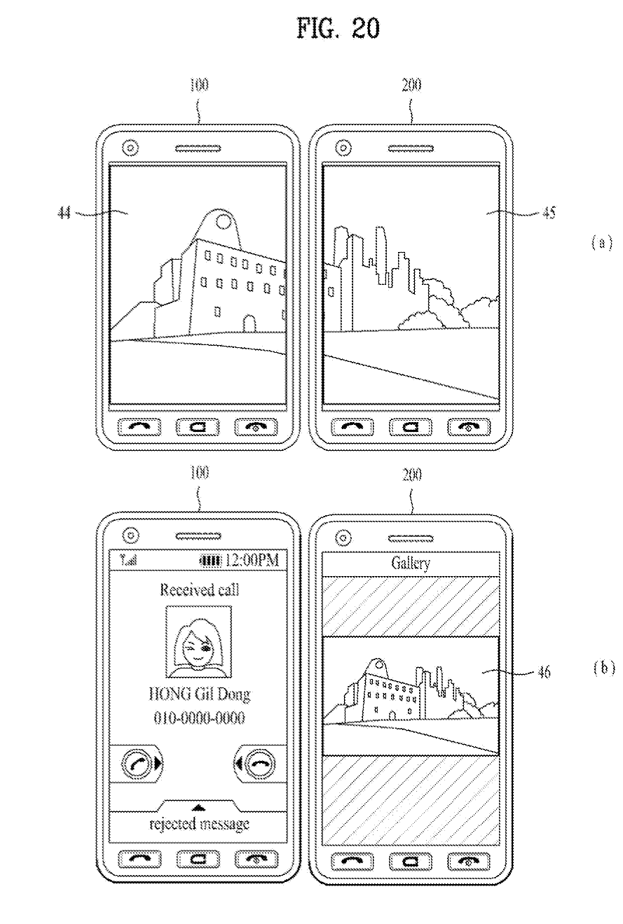

FIG. 20A and FIG. 20B are diagrams for one example to describe a display change between a 1^{st} display unit and an external terminal when a mobile terminal in an active wide mode receives a message.

Referring to FIG. 20A and FIG. 20B, while the 1^{st} display unit 151 and the 2^{nd} display unit are outputting a full image partitioned into a 1^{st} image 44 and a 2^{nd} image 45, if the wireless communication unit 110 receives a call signal [FIG. 20A], the controller 180 enters a phone module and the outputs a screen corresponding to the phone module to the 1^{st} display unit 151 to enable a user to answer a phone. As the screen of the 1^{st} display unit 151 is switched to the screen corresponding to the phone module, the controller 180 may be able to control the external terminal 200 to output a full image 46 resulting from adding the 1^{st} image 44 and the 2^{nd} image 45 to each other [FIG. 20B].

If the phone module is ended, the controller 180 may control the 1^{st} display unit 151 to output the 1^{st} image 44 and may control the external terminal 200 to return to the state of outputting the 2^{nd} image 45, as shown in FIG. 20A.

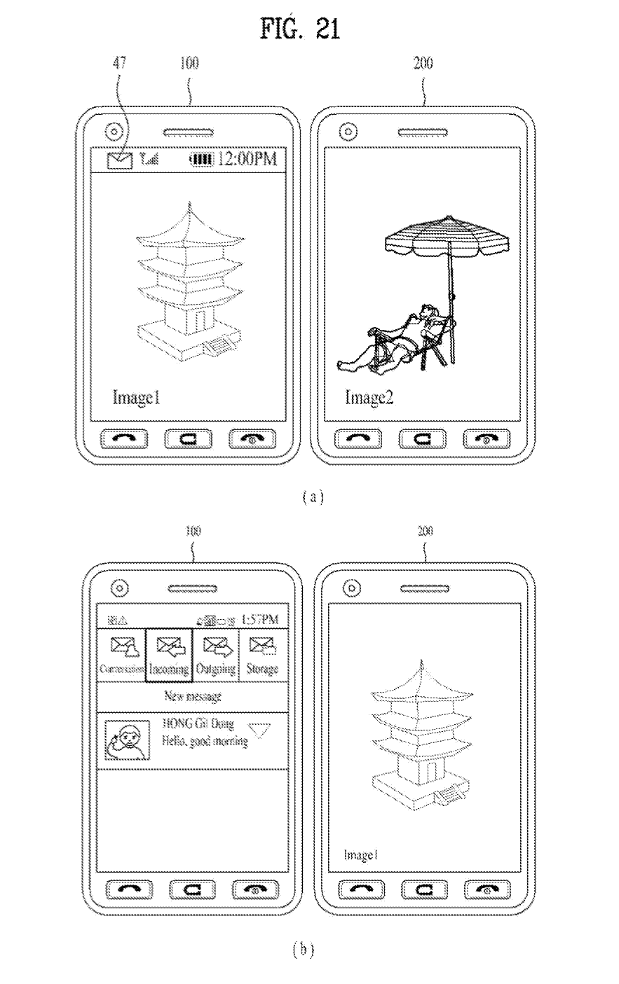

FIG. 21A and FIG. 21B are diagrams for one example to describe a display change between a 1^{st} display unit and an external terminal when a mobile terminal in an active screen partition mode receives a message.

FIG. 21A shows a case that the mobile terminal receives a message. Referring to FIG. 21A, while the 1^{st} display unit 151 and the external terminal 200 are outputting a 1^{st} image Image 1 and a 2^{nd} image Image 2, respectively, if a message is received via the wireless communication unit 110, the controller 180 may control an icon 47, which indicates that a new message is received, to be displayed on a top portion of the screen.

Subsequently, in order for a user to check the new message, if the user applies a user input to switch to a message module, the controller 180 may enter the message module and may control an activated screen of the message module to be displayed on the 1^{st} display unit 151. Moreover, referring to FIG. 21B, the controller 180 may be able to control the 1^{st} image, which used to be outputted via the 1^{st} display unit 151, to be displayed via the external terminal 200.

If the message module is ended, the controller 180 may control the 1^{st} display unit 151 to output the 1^{st} image and may control the external terminal 200 to output the 2^{nd} image.

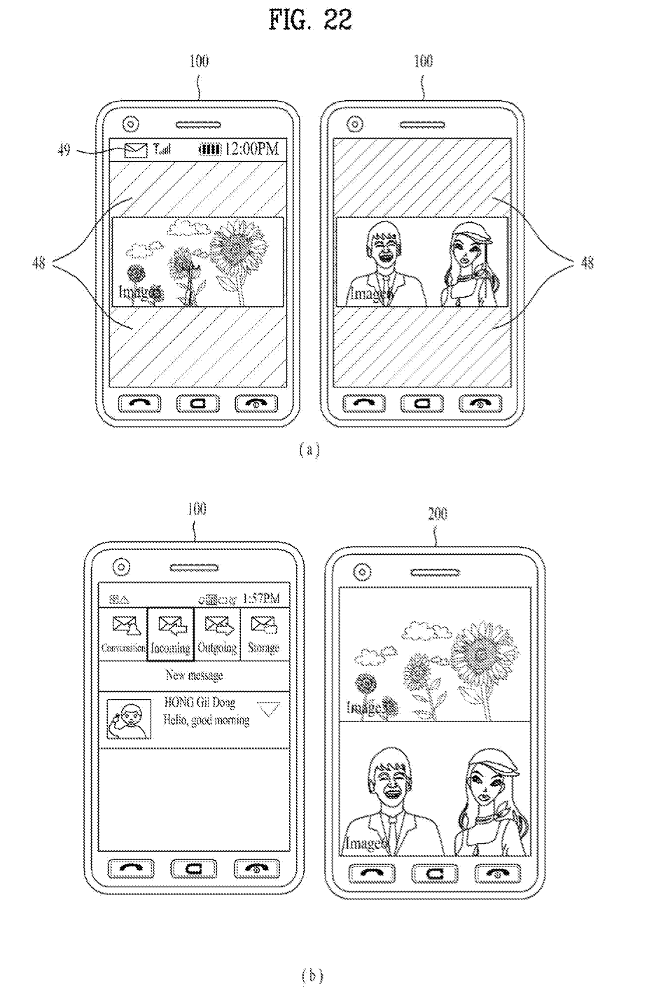

FIG. 22A and FIG. 22B are diagrams for another example to describe a display change between a 1^{st} display unit and an external terminal when a mobile terminal in an active screen partition mode receives a message.

Referring to FIG. 22A, as the 1^{st} display unit 151 and the external terminal 200 output landscape images (i.e., 5^{th} image Image 5 and 6^{th} image Image 6), respectively, blanks are generated from the 1^{st} display unit 151 and the external terminal 200, respectively. Subsequently, if a message is received via the wireless communication unit 110, the controller 180 may be able to display an icon 49, which indicates that a new message is received, on a top portion of the screen.

In order for a user to check the new message, if the user applies a user input to switch to a message module, the controller 180 enters the message module and controls an activated screen of the message module to be displayed on the 1^{st} display unit 151. Moreover, referring to FIG. 22B, the controller 180 may be able to control the external terminal 200 to simultaneously display the 5^{th} image Image 5, which used to be displayed via the 1^{st} display unit 151, together with the 6^{th} image Image 6. The controller 180 may transmit the 5^{th} image to the external terminal 200 and may transmit a control signal to the external terminal 200 to display both of the 5^{th} image and the 6^{th} image simultaneously.

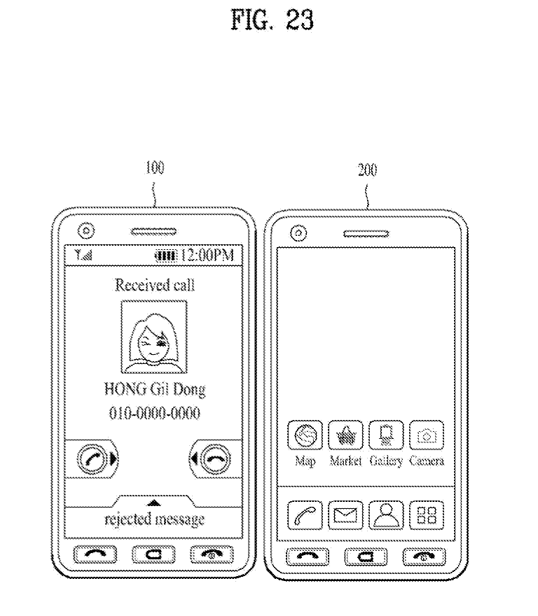

According to another embodiment of the present invention, if an event occurs in the mobile terminal, a multi-screen mode may be paused. FIG. 23 is a diagram for one example of a screen when a multi-screen mode is paused. While the 1^{st} display unit and the external terminal display the 1^{st} image and the 2^{nd} image in FIG. 20A, respectively, or the 1^{st} display unit and the external terminal display the 1^{st} image and the 2^{nd} image in FIG. 21A, respectively, if a call signal is received via the wireless communication unit 110, the controller 180 enters a phone module and may be able to display a screen corresponding to the phone module on the 1^{st} display unit 151. In this case, the controller 180 generates a control signal containing a pause information of a multi-screen mode and may be able to transmit the generated control signal to the external terminal 200 via the wireless communication unit 110. Having received the pause information, the external terminal 200 may be able to enter a standby screen by deviating from the state of displaying the 2^{nd} image. In doing so, the user may be able to activate various functions provided by the external terminal 200 using the external terminal 200.

If the event is ended in the mobile terminal 100 (e.g., if the phone call is ended), the mobile terminal 100 generates a control signal containing a multi-screen more resume information and may be able to transmit the generated control signal to the external terminal 200 via the wireless communication unit 110. If the external terminal 200 receives the multi-screen mode resume information, the external terminal 200 may return to the state of displaying the 2^{nd} image, as shown in FIG. 20A or FIG. 21A.

According to the description of the present embodiment, the case of the event occurrence in the mobile terminal is taken as an example, by which the present invention may be non-limited. For example, if an event occurs in the external terminal 200, the controller 180 may be able to control a partial or full image of a content, which used to be outputted via the external terminal 200, to be transferred to the 1^{st} display unit 151.

### 6^{th} Embodiment

In order to perform the above-enumerated embodiments, a user may be able to perform a prescribed input action using a pointer. In this case, the controller 180 may set the mobile terminal to enter an unlock mode, in which a prescribed control operation may be performed based on a user input, or a lock mode in which a prescribed control operation may not be performed despite that a user applies a prescribed input.

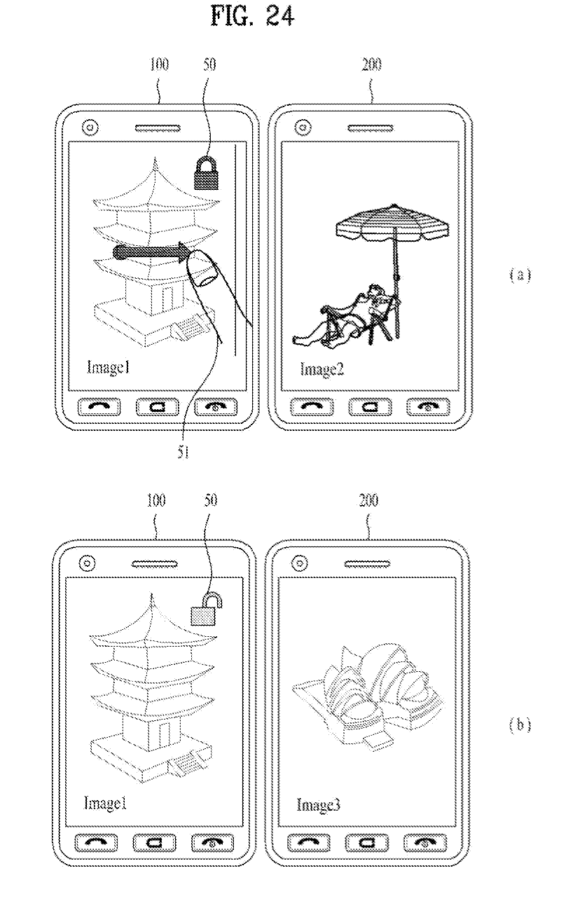

FIG. 24A and FIG. 24B are diagrams for one example of a screen for enabling a controller to set a mobile terminal to enter a lock or unlock mode.

Referring to FIG. 24A and FIG. 24B, a lock icon 50 is displayed on a right top portion of the mobile terminal. If the lock icon 50 is touched with a pointer 51, the controller 180 may be able to set the mobile terminal to enter an unlock mode or a lock mode in response to the touch.

Referring to FIG. 24A, if the lock icon 50 is set to a lock mode, the controller 180 may be set not to respond to a touch input via the pointer 51. In this case, a user may be able to adjust an output of the 1^{st} display unit 151 using the external terminal 200. Hence, the controller 180 receives a user input signal from the external terminal 200 and may be then able to control the output of the 1^{st} display unit 151 based on the received user input signal.

On the contrary, referring to FIG. 24B, if the lock icon 50 is set to an unlock mode, a user applies a touch input to the 1^{st} display unit 151 via the pointer 51, thereby controlling outputs of the 1^{st} display unit 151 and the external terminal 200.

Although FIG. 24A and FIG. 24B show that the unlock mode and the lock mode may be set for the mobile terminal 100 only, the unlock mode and the lock mode may be set for the external terminal 200 as well.

In this case, a user may be able to determine whether a user input can be applied using the mobile terminal 100 or the external terminal 200, via the lock icon 50. In particular, if the lock icon 50 of the mobile terminal 100 is in the lock mode and the lock icon 50 of the external terminal 200 is in the unlock mode, the user may be able to recognize that the user input can be applied via the mobile terminal 100. On the contrary, the user may be able to apply the user input via the external terminal 200.

### 7^{th} Embodiment

First of all, in case that a content is a video, the controller 180 may partition a full image of a video thumbnail into a 1^{st} image and a 2^{nd} image and may then output the 1^{st} image and the 2^{nd} image to the 1^{st} display unit 151 and the external terminal 200, respectively. Alternatively, the controller 180 may control a full image of the video thumbnail to each of the 1^{st} display unit 151 and the external terminal 200.

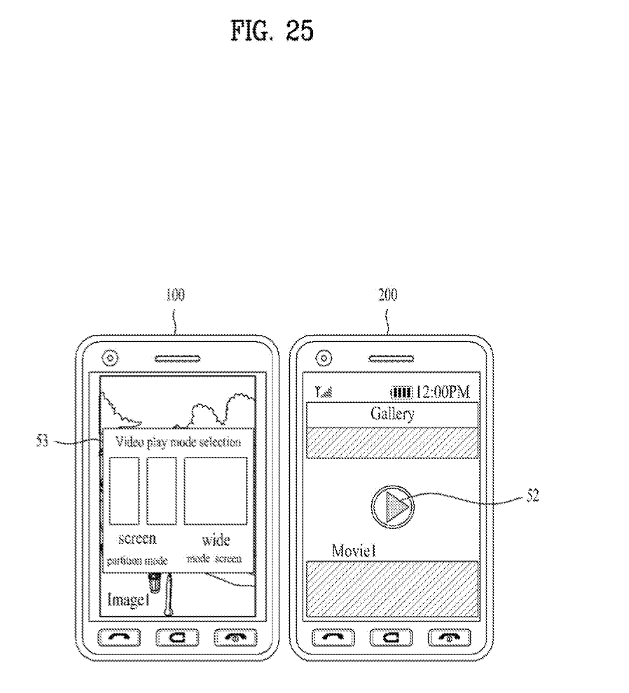

FIG. 25 is a diagram for one example of a screen for displaying a full image of a video thumbnail via an external terminal.

Referring to FIG. 25, the controller 180 may control a play button 52 to be outputted together with a full image of a video thumbnail in a manner of being placed on the full image. If the video play button is touched with a pointer, the controller 180 outputs a popup 53 to the 1^{st} display unit 151 to enable a user to select whether to play the video via one of the 1^{st} display unit 151 and the 2^{nd} display unit or both of the 1^{st} display unit 151 and the 2^{nd} display unit. If the user sets the video to be played using both of the 1^{st} display unit 151 and the 2^{nd} display unit simultaneously, the controller 180 controls the same video, which is played by the external terminal 200, to be played and may control a 1^{st} image of the video and a 2^{nd} image of the video different from the 1^{st} image to be displayed on the 1^{st} display unit 151 and the 2^{nd} display unit, respectively.

The descriptions of the above-enumerated embodiments take the example of transmitting the content stored in the mobile terminal 100 to the external terminal 200, by which the present invention may be non-limited. For example, the controller 180 may be set to a default in a manner that 1^{st} and 2^{nd} images of a full image of the content (or a full image of a 1^{st} content and a full image of a 2^{nd} content) stored in the memory 160 can be displayed via the 1^{st} display unit 151 and the external terminal 200, respectively. If a user makes a request for displaying the content stored in the external terminal 200, the controller may control 1^{st} and 2^{nd} images of a full image of the content (or a full image of a 1^{st} content and a full image of a 2^{nd} content) stored in the external terminal 200 to be displayed via the 1^{st} display unit 151 and the external terminal 200, respectively. In particular, if the controller 180 transmits a content request signal for requesting a content transmission to the external terminal 200 via the wireless communication unit 110, the controller 180 may be able to receive the content stored in the external terminal 200. If the content is received from the external terminal 200, the controller 180 controls the 1^{st} image in the full image of the content received from the external terminal 200 to be outputted via the 1^{st} display unit 151 and may be able to generate a control signal to enable the 2^{nd} image in the full image of the same content to be outputted via the external terminal 200. The generated control signal is then transmitted to the external terminal 200 via the wireless communication unit 110, whereby the 1^{st} display unit 151 and the external terminal 200 can display the 1^{st} image and the 2^{nd} image in the full image of the same content, respectively.

Optionally, if the content (e.g., image) stored in the mobile terminal 100 is fully appreciated, the controller 180 may be set to automatically appreciate the content stored in the external terminal 200.

According to the above-mentioned embodiment, the 1^{st} display unit 151 and the external terminal 200 output a 1^{st} image and a 2^{nd} image, into which a full image of a prescribed content is partitioned, respectively, or a full image of a 1^{st} content and a full image of a 2^{nd} content, respectively, by which the present invention may be non-limited.

For example, the controller 180 may control the 1^{st} display unit 151 to display a full image of a content and may also control the external terminal 200 to output such a virtual keyboard as a touchpad and the like.

According to the above embodiment, it is assumed that one external terminal 200 is present. Yet, the mobile terminal may be operable by being connected with a plurality of external terminals 200.

For example, if two external terminals 200 are present, the controller 180 may control the 1^{st} display unit 151 and the 1^{st} external terminal 200 to display a 1^{st} image and a 2^{nd} image, into which a full image of a 1^{st} content is partitioned, respectively, and may control the 2^{nd} external terminal 200 to display a full image of a 2^{nd} content different from the 1^{st} content.

Moreover, the above-mentioned embodiments may be performed separately, by which the present invention may be non-limited. For example, at least two of the above-mentioned embodiments may be implemented in a single mobile terminal in a manner of being combined together.

According to one embodiment of the present invention, the above-described methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet).

The above-described mobile terminal may be achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a display unit configured to display information;
a wireless communication unit configured to perform communication with at least one other terminal;
a memory configured to store information; and
a controller configured to:
control the display unit to display a first image of a full image of a first content; and
control the at least one other terminal to display a second image of the full image of the first content,
wherein:
the displayed second image is different from the displayed first image; and
the second image is displayed at the same time as the first image.

2. The mobile terminal of claim 1, wherein the controller is further configured to:
compare display information of the display unit with display information of the at least one other terminal; and
control the display unit based on the comparison.

3. The mobile terminal of claim 2, wherein the display information of the display unit or the at least one other terminal comprises at least a screen resolution, a screen size or a screen brightness.

4. The mobile terminal of claim 3, wherein the controller is further configured to:
determine whether the display unit or the at least one other terminal has a lower screen resolution; and
control at least the display unit or the at least one other terminal to adjust its screen resolution according to the determination.

5. The mobile terminal of claim 3, wherein the controller is further configured to:
determine whether the display unit or the at least one other terminal has a smaller screen size; and
control the display unit to adjust display size of the first image or the at least one other terminal to adjust the display size according to the determination.

6. The mobile terminal of claim 3, wherein the controller is further configured to:
determine whether the display unit or the at least one other terminal has a higher screen brightness; and
control the display unit or at least one other terminal to adjust its screen brightness according to the determination.

7. The mobile terminal of claim 1, wherein the wireless communication unit is further configured to transmit the first or second image to the at least one other terminal.

8. The mobile terminal of claim 1, wherein the controller is further configured to determine a presence of the at least one other terminal via a radio frequency signal received from the at least one other terminal.

9. The mobile terminal of claim 8, wherein the received radio frequency signal is transferred via at least WiFi Direct, Bluetooth™, ZigBee™, Radio Frequency Identification (RFID), Ultra-Wideband (UWB), Infrared Data Association (IrDA) or Near Field Communication (NFC).

10. The mobile terminal of claim 8, wherein the controller is further configured to:
display the first and second images in a multi-screen mode;
no longer display the first and second images in the multi-screen mode when a strength of the received radio frequency signal is equal or less than a predetermined value.

11. The mobile terminal of claim 7, wherein the controller is further configured to recognize a direction of the at least one other terminal relative to the location of the display unit.

12. The mobile terminal of claim 1, wherein the controller is further configured to control the display unit or the at least one other terminal to rotate a display of a screen by 180 degrees.

13. The mobile terminal of claim 1, wherein the controller is further configured to:
control the display unit to display the full image of the first content; and
control the at least other terminal to display the full image of a second content at the same time as the display of the full image of the first content, wherein the displayed second content is different from the displayed first content.

14. The mobile terminal of claim 13, wherein the display unit and the at least one other terminal have a same display mode.

15. The mobile terminal of claim 1, wherein the controller is further configured to:
initiate the multi-screen mode;
control the display unit to display the first image and control the at least one other terminal to display the second image when the controller initiates the multi-screen mode; and
terminate the multi-screen mode when an event occurs via the wireless communication unit.

16. The mobile terminal of claim 15, wherein the controller is further configured to generate a use log when the multi-screen mode is terminated.

17. The mobile terminal of claim 16, wherein the controller is further configured to:
re-initiate a multi-screen mode;
read the generated use log and control at least the display unit or the at least one other terminal to display a last displayed image when the multi-screen mode is re-initiated.

18. The mobile terminal of claim 1, wherein the controller is further configured to:
control the display unit to display the full image of the first content; and
control the at least one other terminal to display a virtual keypad at the same time as the display of the full image of the first content.

19. A method of controlling a mobile terminal, the method comprising:
initiating a multi-screen mode by a controller;
displaying a first image of a full image of a content on a display unit; and
displaying a second image of the full image on the at least one other terminal when the multi-screen mode is initiated,
wherein:
the second image is displayed at the same time as the first image; and
the displayed second image is different from the displayed first image.

20. A computer-readable medium comprising a program for controlling a mobile terminal, the computer-readable medium comprising:
a command to initiate a multi-screen mode;
a command to display a first image in a full image of a content on a display unit; and
a command to display a second image on at least one other terminal when the multi-screen mode is initiated, wherein the command to display the second image is different from the command to display the first image.
